(19) United States
(12) Patent Application Publication
(10) Pub. No.: US 2001/0042068 A1
(43) Pub. Date: Nov. 15, 2001

(54) Methods and apparatus for data classification, signal processing, position detection, image processing, and exposure

(75) Inventors: Kouji Yoshida, Tokyo (JP); Masafumi Mimura, Kawasaki-shi (JP); Taro Sugihara, Kawasaki-shi (JP); Yuuji Kokumai, Kawasaki-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Nikon Corporation, Chiyoda-ku, Tokyo (JP)

(21) Appl. No.: 09/758,289

(22) Filed: Jan. 12, 2001

(30) Foreign Application Priority Data
Jan. 13, 2000 (JP) 2000-004,723
Dec. 15, 2000 (JP) 2000-381,783

(51) Int. Cl. G06F 17/30

(52) U.S. Cl. 707/102; 707/5

(57) ABSTRACT

A degree-of-randomness calculation unit calculates the degrees of randomness of data values in the respective data sets as division results, on feature amount data at feature points of the signal waveforms obtained when an image pick-up unit picks up images of marks, while changing the data division form, in the respective data division forms, and calculates the sum of the degrees of randomness. A classification calculation unit classifies the feature points in the data division form in which the sum of degrees of randomness is minimized, thereby classifying the feature amount data into signal data and noise data. A position calculation unit calculates mark position information on the basis of the position of the feature point determined as signal data by S/N discrimination with reference to such degrees of randomness. As a consequence, the position information of each mark formed on the object is accurately detected.

### BACKGROUND OF THE INVENTION

1. Field of the Invention

The present invention relates to a data classification method and apparatus, signal processing method and apparatus, position detection method and apparatus, image processing method and apparatus, exposure method and apparatus, recording medium, and device manufacturing method and, more specifically, a data classification method and apparatus which are effective in discriminating the presence/absence of noise data in acquired data, a signal processing method using the data classification method, a position detection method using the signal processing method, an image processing method and apparatus which use the data classification method, and an exposure method and apparatus which use the position detection method or image processing method. The present invention also relates to a storage medium storing a program for executing the data classification method, signal processing method, position detection method, or image processing method, and a device manufacturing method using the exposure method.

2. Description of the Related Art

In a lithography process for manufacturing a semiconductor device, liquid crystal display device, or the like, an exposure apparatus has been used. In such an exposure apparatus, patterns formed on a mask or reticle (to be generically referred to as a “reticle” hereinafter) are transferred through a projection optical system onto a substrate such as a wafer or glass plate (to be referred to as a “substrate or wafer” hereinafter, as needed) coated with a resist, etc. As apparatuses of this type, a static exposure type projection exposure apparatus, e.g., a so-called stepper, and a scanning exposure type projection exposure apparatus, e.g., a so-called scanning stepper are mainly used.

In such an exposure apparatus, positioning (alignment) of a reticle and wafer must be accurately performed before exposure. To perform this alignment, position detection marks (alignment marks) formed (exposure-transferred) in the previous lithography process are provided in the respective shot areas on the wafer. By detecting the positions of these alignment marks, the position of the wafer (or a circuit pattern on the wafer) can be detected. Alignment is then performed on the basis of the detection result on the position of the wafer (or the circuit pattern on the wafer).

Currently, several methods of detecting the position of each alignment mark on a wafer have been put into practice. In each method, the waveform of a signal obtained as a detection result on an alignment mark by a position detector is analyzed to detect the position of the alignment mark formed by a line pattern and space pattern each having a predetermined shape on the wafer. In position detection based on image detection, which has currently become mainstream, an optical image of each alignment mark is picked up by an image pick-up unit, and the image pick-up signal, i.e., the light intensity distribution of the image, is analyzed to detect the position of the alignment mark. As such an alignment mark, for example, a line-and-space mark having line patterns (straight line patterns) and space patterns alternately arranged along a predetermined direction is used.

In position detection based on such image detection, the waveform of a signal reflecting the light intensity distribution of the mark image obtained as an image pick-up result on a mark is analyzed. Such a signal waveform exhibits a characteristic peak shape at a boundary (to be referred to as an “edge” hereinafter) portion between a line pattern and a space pattern of a mark. A similar peak waveform is also produced by incidental noise.

For this reason, to accurately detect a mark position, it is necessary to identify a peak shape originating from noise and a peak shape of a rare signal. The following method has been used to identify such peak shapes. First of all, images of many marks are picked up in advance in each manufacturing process. A threshold signal level that can discriminate a signal peak from a noise peak is obtained in advance from the peak heights of peak waveforms obtained from the image pick-up results in accordance with a relationship (e.g., TH% of the maximum peak height) with the signal waveforms obtained from the image pick-up results. In actually detecting a mark position, a peak exceeding the threshold is used as a signal peak on the basis of the signal waveform obtained from the image pick-up result on the mark.

In addition, in order to accurately detect the position of each alignment mark formed on the wafer, the alignment mark formed at a predetermined position on the wafer must be observed at a high magnification. When observation is performed at a high magnification, the observation field inevitably becomes narrow. To reliably detect an alignment mark with a narrow observation field, the central position or rotation of the wafer in a reference coordinate system that defines the movement of the wafer is detected with a predetermined precision before the detection of the position of the alignment mark. This detection is performed by observing the peripheral shape of the wafer and obtaining the position of a notch or orientation flat of the peripheral portion of the wafer, the position of the peripheral portion of the wafer, or the like.

In observing the peripheral shape of the wafer, when an image of a portion near the peripheral portion (the peripheral portion of the wafer and its background area) of the silicon wafer that has generally been used is picked up, an image pick-up result exhibiting almost uniform brightness (luminance) is obtained on at least the wafer side. For this reason, the image pick-up data can be binarized into an image pick-up result on the wafer and an image pick-up result on the background area, and the boundary between the wafer image and the background area is automatically discriminated on the basis of the binarized image data.

According to the above conventional signal peak extraction method, to obtain a threshold signal level used to discriminate a signal peak from a noise peak, experimental trial and error associated with many marks is required in advance in each manufacturing process. For this reason, it takes much time for preparation.

In addition, if an inexperienced manufacturing process is used, since the threshold obtained previously cannot always be used, many marks must be observed in the inexperienced manufacturing process to obtain a new threshold again. This equally applies to a case wherein a mark having a new shape is used.

In observing many marks in a signal process in advance, however, the number of marks is limited. That is, the waveform patterns of all signals cannot be covered. If, therefore, a signal waveform obtained from a mark-image pick-up result in detecting the position of a mark is completely new, the position of the mark cannot be detected with high precision.

As demand has arisen for an improvement in exposure precision with an increase in integration degree, it is expected that new processes and positioning marks having new shapes will be used. That is, demand has arisen for a new technique of detecting a mark position with high precision by identifying signal data and noise data in signal waveform data obtained by actual measurement and processing the signal data.

Recently, glass wafers are increasingly used as wafers in addition to silicon wafers. In the case of such a glass wafer, an image pick-up result exhibiting almost uniform brightness (luminance) cannot always be obtained on the wafer side. By using the conventional techniques, therefore, the boundary between a wafer image and a background area cannot be automatically discriminated.

### SUMMARY OF THE INVENTION

The present invention has been made in consideration of the above situation, and has as its first object to provide a data classification method and apparatus which can rationally and efficiently classify a group of data according to data values.

It is the second objet of the present invention to provide a signal processing method and apparatus which can reliably and efficiency discriminate noise in the waveform obtained by observation.

It is the third object of the present invention to provide a position detection method and apparatus which can accurately detect the position of a mark formed on an object.

It is the fourth object of the present invention to provide an image processing method and apparatus which can accurately identify the boundary between an object and a background in an image pick-up result on the object.

It is the fifth object of the present invention to provide an exposure method and apparatus which can accurately transfer a predetermined pattern onto a substrate.

It is the sixth object of the present invention to provide a device manufacturing method which can manufacture a high-density device having a fine pattern.

According to the first aspect of the present invention, there is provided a first data classification method of classifying a group of data into a plurality of sets in accordance with data values, comprising: dividing the group of data into a first number of sets having no common elements; and calculating a first total degree of randomness which is a sum of degrees of randomness of the data values in the respective sets of the first number of sets, wherein data division to the first number of sets and calculation of the first total degree of randomness are repeated while a form of data division to the first number of sets is changed, and the group of data is classified into data belonging to the respective classification sets of the first number of classification sets in which the first total degree of randomness is minimized.

According to this method, the degrees of randomness of the data values in the respective sets of the first number of sets obtained by data division are calculated, and the first total degree of randomness which is the sum of these degrees of randomness is calculated. Such data division and calculation of the sum of degrees of randomness are repeated in all data division forms or for a statistically sufficient number of types of data divisions, and the group of data are classified in the data division form in which the first total degree of randomness is minimized. That is, the group of data are divided into the first number of classification sets each consisting of similar data values with reference to the degree of randomness of data value distributions. Therefore, signal data candidates regarded as data having similar data values can be automatically and rationally obtained from a group of data including noise data that can take various data without preliminary measurement and the like.

The first data classification method of the present invention further comprises: dividing data belonging to a specific classification set in the first number of classification sets into a second number of sets having no common elements; and calculating a second total degree of randomness which is a sum of degrees of randomness of data values in the respective sets of the second number of sets, wherein data division to the second number of sets and calculation of the second total degree of randomness are repeated while a form of data division to the second number of sets is changed, and the data belonging to the specific classification set are further classified into data belonging to the respective classification sets of the second number of classification sets in which the second total degree of randomness is minimized.

In this case, at least the data in one specific classification set of the first number of classification sets obtained by classifying the group of data in the above manner are classified into the second number of classification sets with reference to the degree of randomness. Even if, therefore, data candidates cannot be classified with a high resolution by data division to the first number of classification sets, data candidates can be automatically and rationally obtained with a desired resolution.

In the first data classification method of the present invention, the data division can be performed with respect to data subjected to the division in numerical order of data values. In this case, since data division is not performed randomly but is performed in numerical order of data values, the number of data division forms can be decreased. Assume that the total number of data of a group of data is represented by N, and the data are classified into two classification sets. In this case, if data division is performed randomly, the total number of data division forms is about 2^{N-1}. In contrast to this, if data division is performed in numerical order, the total number of data division forms is only (N−3). Consequently, the data division can be quickly performed.

According to the first data classification method of the present invention, the degree of randomness of each set can be obtained by estimating the probability distribution of the data values in each set on the basis of the data values of the data belonging to each set, obtaining the entropy of the estimated probability distribution of the data values, and setting a weight in accordance with the number of data belonging to the set corresponding to the entropy of the probability distribution.

In this case, the probability distribution of the data values can be estimated as a normal distribution. Estimating the probability distribution of data values in each set as a normal distribution in this manner is especially effective in a case wherein variations in data value can be regarded as normal random variations. Note that if the probability distribution of data values is known, this distribution can be used. If a probability distribution is totally unknown, it is rational that a normal distribution which is the most general probability distribution is estimated as a probability distribution.

According to the second aspect of the present invention, there is provided a first data classification apparatus for classifying a group of data into a plurality of sets in accordance with data values, comprising: a first data dividing unit which divides the group of data into a first number of sets having no common elements; and a first degree-of-randomness calculation unit which calculates degrees of randomness of data values in the respective sets divided by the first data dividing unit, and calculating a sum of the degrees of randomness; and a first classification unit which classifies the group of data into the data belonging to the respective classification sets of the first number of classification sets in which the sum of degrees of randomness calculated by the first degree-of-randomness calculation unit in each form of data division by the first data dividing unit is minimized.

According to this apparatus, while the first data dividing unit changes the data division form associated with the group of data, the first degree-of-randomness calculation unit calculates the degree of randomness of data values in each set in each data division form and calculates the sum of degrees of randomness. The first classification unit classifies the group of data in the data division form in which the sum of degrees of randomness is minimized. That is, since data are classified by the data classification method of the present invention with reference to the degree of randomness of data value distributions, signal data candidates can be automatically and rationally classified from the group of data.

The first data classification apparatus of the present invention further comprises: a second data dividing unit which divides data belonging to a specific classification set in the first number of classification sets into a second number of sets having no common elements; and a second degree-of-randomness calculation unit which calculates degrees of randomness of data values in the respective sets divided by the second data dividing unit, and calculating a sum of the degrees of randomness; and a second classification unit which classifies the data of the specific classification set into the data belonging to the respective classification sets of the second number of classification sets in which the sum of degrees of randomness calculated by the second degree-of-randomness calculation unit in each form of data division by the second data dividing unit is minimized.

According to the third aspect of the present invention, there is provided a signal processing method of processing a measurement signal obtained by measuring an object, comprising: extracting signal levels at a plurality of feature points obtained from the measurement signal; and setting the extracted signal levels as classification object data and classifying the signal levels at the group of feature points into a plurality of sets by using the data classification method of the present invention. In this specification, the classification object data means data to be classified.

According to this method, signal levels at a plurality of feature points extracted from the measurement signal obtained by measuring an object are set as classification object data, and signal data candidates are classified by using the data classification method of the present invention. More specifically, the signal waveform data of the measurement signal are classified into signal component data candidates and noise component data candidates by using the data classification method of the present invention, noise discrimination in a signal waveform can be efficiently and automatically performed.

The above feature point may be at least one of maximum and minimum points of the measurement signal or a point of inflection of the measurement signal.

According to the fourth aspect of the present invention, there is provided a signal processing apparatus for processing a measurement signal obtained by measuring an object, comprising: a measurement unit which measures the object and acquiring a measurement signal; an extraction unit which extracts signal levels at a plurality of feature points obtained from the measurement signal; and the data classification apparatus of the present invention, which sets the extracted signal levels as classification object data.

According to this apparatus, the extraction unit extracts signal levels at a plurality of feature points from the measurement signal obtained by the measurement unit that has measured an object. The data classification apparatus of the present invention then sets the extracted signal levels as classification object data and classifies signal data candidates by using the data classification method of the present invention. That is, noise discrimination in a signal waveform can be efficiently and automatically performed by classifying the signal waveform data of the measurement signal into signal component data candidates and noise component data candidates using the signal processing method of the present invention.

According to the fifth aspect of the present invention, there is provided a position detection method of detecting a position of a mark formed on an object, comprising: acquiring an image pick-up signal by picking up an image of the mark; processing the image pick-up signal as a measurement signal by the signal processing method of the present invention; and calculating the position of the mark on the basis of a signal processing result obtained in the signal processing.

According to this method, the image pick-up signal obtained by picking up an image of a mark is processed by the signal processing method of the present invention to discriminate signal components from noise components. The position of the mark is then calculated by using the signal components. Even if, therefore, the form of noise superimposed on the image pick-up signal is unknown, the position of the mark can be automatically and accurately detected.

According to the position detection method of the present invention, the number of data that should belong to each classification set after data classification is known in advance, and the number of data that should belong to each classification set is compared with the number of data in a corresponding one of the classified classification sets to evaluate the validity of the classification. The position of the mark can be calculated on the basis of the data belonging to the classification set evaluated as a valid set.

In this case, whether noise data is mixed in classified signal data candidates is determined by comparing the known number of signal data with the number of data in the signal data candidates after classification. Assume that the number of signal data is equal to the number of data in the signal data candidates after the data classification. In this case, it is determined that no noise data is mixed in the classified signal data candidates, and the classification is evaluated as valid classification. The mark position is then detected on the basis of the data belonging to the classification set. This makes it possible to prevent the mixing of noise data into data for the detection of the mark position. Therefore, the mark position can be accurately detected.

If it is determined that noise data is mixed in the classified signal data candidates, and the classification in the classification step is evaluated as invalid classification, new mark position detection may be performed or the noise data may be removed from the position information of the mark associated with each data in the signal data candidates.

According to the sixth aspect of the present invention, there is provided a signal processing apparatus for processing a measurement signal obtained by measuring an object, comprising: a measurement unit which measures the object and acquiring a measurement signal; an extraction unit which extracts signal levels at a plurality of feature points obtained from the measurement signal; and the data classification apparatus of the present invention, which sets the extracted signal levels as classification object data.

According to this arrangement, the signal processing apparatus of the present invention performs signal processing for the image pick-up signal, as a measurement signal, which is obtained when the image pick-up unit picks up an image of a mark, so as to discriminate signal component data from noise component data. That is, the position detection apparatus of the present invention detects the mark position by using the position detection method of the present invention. Even if, therefore, the form of noise superimposed on an image pick-up signal is unknown, the position of the mark can be automatically and accurately detected.

According to the seventh aspect of the present invention, there is provided a first exposure method of transferring a predetermined pattern onto a divided area on a substrate, comprising: detecting a position of a position detection mark formed on the substrate by the position detection method of the present invention, obtaining a predetermined number of parameters associated with a position of the divided area, and calculating arrangement information of the divided area on the substrate; and transferring the pattern onto the divided area while performing position control on the substrate on the basis of the arrangement information of the divided area obtained in the arrangement calculation.

According to this method, in the arrangement calculation step, the position of the position detection mark formed on the substrate is accurately detected by using the position detection method of the present invention, and the arrangement coordinates of the divided area on the substrate are calculated on the basis of the detection result. In the transferring, the pattern can be transferred onto the divided area while the substrate is positioned on the basis of the calculation result on the arrangement coordinates of the divided area. This makes it possible to accurately transfer the predetermined pattern onto the divided area.

According to the eighth aspect of the present invention, there is provided a first exposure apparatus for transferring a predetermined pattern onto a divided area on a substrate, comprising: a substrate stage on which the substrate is mounted; and the position detection apparatus of the present invention, which detects a position of the mark on the substrate.

According to this arrangement, the position of the mark on the substrate, i.e., the position of the substrate, can be accurately detected by using the position detection apparatus of the present invention. Therefore, the substrate can be moved on the basis of the accurately obtained position of the substrate. As a consequence, the predetermined pattern can be transferred onto the divided area on the substrate with improved precision.

Note that the first exposure apparatus of the present invention is manufactured by mechanically, optically, and electrically combining and adjusting other various components and provides a substrate stage on which the substrate is mounted and a position detection apparatus of the present invention which detects the position of the mark on the substrate.

According to the ninth aspect of the present invention, there is provided a second data classification method of classifying a group of data into a plurality of sets in accordance with data values, comprising: classifying the group of data into a first number (a) of sets in accordance with the data values; and dividing the group of data again into a second number (b<a) of sets which is smaller than the first number (a) on the basis of a characteristic of each of the first number (a) of sets divided in the classifying the data into the first number of sets.

According to this method, the group of data are divided into the first number of sets on the basis of the data values. For each of the first number of data sets obtained by data division, features such as a frequency distribution or probability distribution in the corresponding data distribution are analyzed. The group of data are then divided again into the second number of sets on the basis of the features of each of the first number of data sets obtained as the analysis result. As a consequence, the group of data can be rationally and efficiently divided into the desired second number of sets in accordance with the data values.

According to the second data classification method of the present invention, the second step comprises: specifying a first set, out of the first number (a) of sets, which meets a predetermined condition; estimating a first boundary candidate for dividing the group of data excluding data included in the first set by using a predetermined estimation technique; estimating a second boundary candidate for dividing a data group, out of the group of data, which is defined by the first boundary candidate and includes the first set by using the predetermined estimation technique; and dividing the group of data into the second number (b) of sets on the basis of the second boundary candidate.

In this case, the predetermined estimation technique comprises: calculating a degree of randomness of data values in each set divided by the boundary candidate, and calculating a sum of the degrees of randomness; and performing the degree-of-randomness calculation step while changing a form of data division with the boundary candidate, and extracting a boundary candidate with which the sum of degrees of randomness obtained in the degree-of-randomness calculation step is minimized.

In addition, the predetermined estimation technique comprises; obtaining a probability distribution in each set of the data group; and extracting the boundary candidate on the basis of a point of intersection of the probability distributions of the respective sets.

Furthermore, the predetermined estimation technique comprises the steps of: calculating an intra-class variance as a variance between sets divided by the boundary candidate; and performing the intra-class variance calculation step while changing a form of data division with the boundary candidate, and extracting a boundary candidate with which the intra-class variance obtained in the intra-class variance calculation step is maximized.

The predetermined condition may be a condition that data exhibiting a value substantially equal to a predetermined value is extracted from the group of data. In this case, the group of data may be image pick-up data of the respective pixels obtained by picking up different image patterns within a predetermined image pick-up field. The predetermined value may be image pick-up data of pixels existing in an area corresponding to an image pick-up area for a predetermined image pattern.

According to the second data classification method of the present invention, the dividing data into the second number of sets comprises: extracting a predetermined number of sets from the first number (a) of sets on the basis of the numbers of data included in the respective sets of the first number (a) of sets; calculating an average data value by averaging data values respectively representing the sets of the predetermined number of sets; and dividing the group of data into the second number (b) of sets on the basis of the average data value.

In the average data value calculation, a weighted average of the data values can be calculated by using a weight corresponding to at least one of the number of data of the respective sets of the predetermined number of sets and a probability distribution of the predetermined number of sets.

According to the second data classification method of the present invention, the first number (a) can be three or more, and the second number (b) can be two.

In addition, according to the second data classification method of the present invention, the group of data can be luminance data of the respective pixels obtained by picking up different image patterns within a predetermined image pick-up field.

According to the 10th aspect of the present invention, there is provided a second data classification apparatus for classifying a group of data into a plurality of sets in accordance with data values, comprising: a first data dividing unit which divides the group of data into a first number (a) of sets on the basis of the data values; and a second data dividing unit which divides the group of data into a second number (b<a) of sets smaller than the first number (a) again on the basis of a characteristic of each of the first number (a) of sets.

According to this method, the first data dividing unit divides the group of data into the first number of sets on the basis of the respective data values. The second data dividing unit divides the group of data into the second number of sets again on the basis of the features of the respective data sets of the first number of data sets obtained by data division. That is, the second data classification apparatus of the present invention divides the group of data into the second number of sets by using the second data classification method of the present invention. Therefore, the group of data can be rationally and efficiently divided into the desired second number of sets in accordance with the data values.

In the second data classification apparatus of the present invention, the first number (a) can be three or more, and the second number (b) can be two.

According to the 11th aspect of the present invention, there is provided a third data classification method of classifying a group of data into a plurality of sets in accordance with data values, comprising: estimating a first number (c) of boundary candidates for dividing the group of data into a second number of sets on the basis of the data values; and extracting a third number (d<c) of boundary candidates which is smaller than the first number (c) and is used to divide the group of data into a fourth number of sets smaller than the second number, under a predetermined extraction condition, on the basis of the first number of boundary candidates.

According to this method, the first number of boundary candidates for dividing the group of data into the second number of sets is estimated. A predetermined extraction condition corresponding to the form of data division to the third number smaller than the desired second number is applied to the first number of boundary candidates to extract the third number of boundary candidates for dividing the data into the fourth number of sets. As a consequence, the third number of boundary candidates can be rationally and efficiently extracted, and hence the group of data can be rationally and efficiently divided into the desired fourth number of sets in accordance with the data values.

According to the third data classification method of the present invention, the predetermined extraction condition can be a condition that the third number (d) of boundary candidates are extracted on the basis of the magnitudes of the data values of respective boundary candidates of the first number (c) of boundary candidates.

In this case, the predetermined extraction condition can be a condition that a boundary candidate of which the data value is maximum is extracted.

According to the third data classification method of the present invention, the group of data are respectively arranged at positions in a predetermined direction, and the predetermined extraction condition an be a condition that the third number (d) of boundary candidates are extracted on the basis of the respective positions of the first number (c) of boundary candidates.

According to the third data classification method of the present invention, the group of data are differential data obtained by differentiating image pick-up data of the respective pixels obtained by picking up different image patterns in a predetermined image pick-up field in accordance with positions of the pixels, the data value is a differential value of the image pick-up data, and the boundary candidate is a position of the pixel.

According to the third data classification method of the present invention, the first number (c) can be two or more, and the second number (d) can be one.

According to the third data classification method of the present invention, the group of data can be luminance data of the respective pixels obtained by picking up different image patterns in a predetermined image pick-up field.

According to the 12th aspect of the present invention, there is provided a third data classification apparatus for classifying a group of data into a plurality of sets in accordance with data values, comprising: a first data dividing unit which estimates a first number (c) of boundary candidates for dividing the group of data into a second number of sets on the basis of the data values; and a second data dividing unit which extracts a third number (d) of boundary candidates which is smaller than the first number (c) and is used to divide the group of data into a fourth number of sets smaller than the second number, under a predetermined extraction condition, on the basis of the first number (c) of boundary candidates.

According to this arrangement, the first data dividing unit estimates the first number of boundary candidates for dividing the group of data into the second number of sets. The second data dividing unit then extracts the third number of boundary candidates for dividing the data into the fourth number of sets smaller than the second number, under a predetermined extraction condition, on the basis of the first number of boundary candidates estimated by the first data dividing unit. That is, the third data classification apparatus of the present invention divides the group of data into the fourth number of sets by using the third data classification method of the present invention. Therefore, the group of data can be rationally and efficiently divided into the desired fourth number of sets in accordance with the data values.

According to the third data classification apparatus of the present invention, the group of data are differential data obtained by differentiating image pick-up data of the respective pixels obtained by picking up different image patterns in a predetermined image pick-up field in accordance with positions of the pixels, the data value is a differential value of the image pick-up data, and the boundary candidate can be a position of the pixel.

According to the third data classification apparatus of the present invention, the first number (c) can be two or more, an the third number (d) can be one.

According to the 13th aspect of the present invention, there is provided an image processing method of processing image data obtained by picking up an image in a predetermined image pick-up field, comprising: setting luminance data, as a group of data, which is obtained by picking up an image pattern of an object and an image pattern of a background which exist in the predetermined image pick-up field; and identifying a boundary between the object and the background by classifying the luminance data by using the second or third data classification method of the present invention.

According to this method, the luminance data obtained by picking up an image pattern of an object and an image pattern of a background which exist in the predetermined image pick-up field are set as a group of data, and the luminance data are rationally and efficiently classified into the luminance data of the object and the luminance data of the background by using the second or third data classification method of the present invention. The boundary between the object and the background is then identified on the basis of the data classification result. Therefore, the boundary between the object and the background in the image pick-up result on the object can be accurately identified, and hence the shape of the periphery of the object can be accurately specified.

According to the 14th aspect of the present invention, there is provided an image processing apparatus for processing image data obtained by picking up an image in a predetermined image pick-up field, wherein luminance data which is obtained by picking up an image pattern of an object and an image pattern of a background which exist in the predetermined image pick-up field is set as a group of data, and a boundary between the object and the background is identified by classifying the luminance data by using the second or third data classification apparatus of the present invention.

According to this arrangement, the luminance data obtained by picking up an image pattern of an object and an image pattern of a background which exist in the predetermined image pick-up field are set as a group of data, and the boundary between the object and the background is identified by classifying the luminance data by using the second or third data classification apparatus of the present invention. That is, the image processing apparatus of the present invention identifies the boundary between an object and a background by using the image processing method of the present invention. Therefore, the boundary between an object and a background in an image pick-up result on the object can be accurately identified, and the shape of the periphery of the object can be accurately specified.

According to the 15th aspect of the present invention, there is provided a second exposure method of transferring a predetermined pattern onto a substrate, comprising: specifying an outer shape of the substrate by using the image processing method of the present invention; controlling a rotational position of the substrate on the basis of the specified outer shape of the substrate; detecting a mark formed on the substrate after the rotational position is controlled; and transferring the predetermined pattern onto the substrate while positioning the substrate on the basis of a mark detection result obtained in the mark detection step.

According to this method, in the rotational position control, the rotational position of the substrate is controlled on the basis of the outer shape of the substrate which is accurately specified by using the image processing method of the present invention in specifying the outer shape. Subsequently, a mark formed on the substrate is accurately detected in detecting the mark after the rotational position of the substrate is controlled. A predetermined pattern is then transferred onto the substrate in the transfer step while the substrate is accurately positioned on the basis of the mark detection result. Therefore, the predetermined pattern can be accurately transferred onto the substrate.

According to the 16th aspect of the present invention, there is provided a second exposure apparatus for transferring a predetermined pattern onto a substrate, comprising: an outer shape specifying unit including the second image processing apparatus of the present invention, which specifies an outer shape of the substrate; a rotational position control unit which controls a rotational position of the substrate on the basis of the outer shape of the substrate which is specified by the image processing apparatus; a mark detection unit which detects a mark formed on the substrate whose rotational position is controlled by the rotational position control unit; and a positioning unit which positions the substrate on the basis of a mark detection result obtained by the mark position detection unit, wherein the predetermined pattern is transferred onto the substrate while the substrate is positioned by the positioning unit.

According to this arrangement, the rotational position control unit controls the rotational position of the substrate on the basis of the outer shape of the substrate which is accurately specified by the outer shape specifying unit using the image processing apparatus of the present invention. Subsequently, the mark detection unit detects a mark formed on the substrate after the rotational position of the substrate is controlled. A predetermined pattern is then transferred onto the substrate while the substrate is accurately positioned by the positioning unit on the basis of the mark detection result. That is, the second exposure apparatus of the present invention transfers a predetermined pattern onto a substrate by using the second exposure method of the present invention. Therefore, the predetermined pattern can be accurately transferred onto the substrate.

The second exposure apparatus of the present invention is manufactured by providing an outer shape specifying unit which includes the second mage processing apparatus of the present invention and specifies the outer shape of the substrate; providing a rotational position control unit for controlling the rotational position of the substrate on the basis of the outer shape of the substrate which is specified by the image processing apparatus; providing a mark detection unit for detecting a mark formed on the substrate whose positional position is controlled by the rotational position control unit; and providing a positioning unit for positioning the substrate on the basis of the mark detection result by the mark position detection unit and mechanically, optically, and electrically combining and adjusting other various components.

When the position detection unit is formed as a computer system, the computer system can perform position detection using the position detection method of the present invention by reading out a control program for controlling the execution of the position detection method of the present invention from a recording medium in which the control program is stored, and executing the position detection method of the present invention. Therefore, according to another aspect, the present invention amounts to a recording medium in which a control program for controlling the usage of the first data classification method, signal processing method, or position detection method of the present invention is stored.

When the image processing apparatus is formed as a computer system, the computer system can perform image processing by reading out a control program for controlling the execution of the image processing method of the present invention from a recording medium in which the control program is stored, and executing the image processing method of the present invention. According to another aspect, therefore, the present invention amounts to a recording medium in which a control program for controlling the usage of the second or third data classification method or image processing method of the present invention is stored.

In addition, fine patterns on a plurality of layers can be formed a substrate with a high overlay precision by performing exposure using the exposure method of the present invention. This makes it possible to manufacture high-density microdevices with high yield and improve the productivity. According to still another aspect, the present invention amounts to a device manufacturing method using the exposure method of the present invention.

### BRIEF DESCRIPTION OF THE DRAWINGS

FIG. 1 is a view showing the schematic arrangement of an exposure apparatus according to the first embodiment;

FIGS. 2A and 2B are views for explaining an example of an alignment mark;

FIGS. 3A to 3D are views for explaining image pick-up results on an alignment mark;

FIGS. 4A to 4E are views for explaining the steps in forming a mark through a CMP process;

FIG. 5 is a view showing the schematic arrangement of a main control system in FIG. 1;

FIG. 6 is a flow chart for explaining mark position detecting operation;

FIG. 7 is a graph showing an example of the distribution of pulse height data rearranged in numerical order of pulse height values;

FIG. 8 is a flow chart for explaining the processing in the peak height data classification subroutine in FIG. 6;

FIGS. 9A to 9C are graphs each showing an example of classification of the data of positive peak height values;

FIG. 10 is a view showing the schematic arrangement of an exposure apparatus according to the second embodiment;

FIG. 11 is a plan view schematically showing an arrangement near a rough alignment detection system in the apparatus in FIG. 10;

FIG. 12 is a block diagram showing the arrangement of a main control system in the apparatus in FIG. 10;

FIG. 13 is a flow chart for explaining the operation of the apparatus in FIG. 10;

FIG. 14 is a view for explaining the image pick-up result obtained by the rough alignment detection system;

FIG. 15 is a flow chart for explaining the processing in the wafer outer shape measurement subroutine in FIG. 13;

FIG. 16 is a graph showing the frequency distribution of luminance values in the image pick-up result in FIG. 14;

FIG. 17 is a graph showing the occurrence probability distribution of the luminance values in the image pick-up result in FIG. 14;

FIG. 18 is a graph for explaining how a temporary parameter value T′ (luminance value) is obtained;

FIG. 19 is a graph for explaining how a threshold T (luminance value) is obtained;

FIG. 20 is a view showing an image binarized with the threshold T (luminance value);

FIG. 21 is a graph showing a luminance value waveform and its differential value waveform in the image pick-up result in FIG. 14;

FIG. 22 is a graph for explaining how the differential value waveform in FIG. 21 is analyzed;

FIG. 23 is a view showing an extracted contour;

FIG. 24 is a flow chart for explaining a device manufacturing method using the exposure apparatus in FIG. 1; and

FIG. 25 is a flow chart showing the processing in the wafer processing step in FIG. 24.

### DESCRIPTION OF THE PREFERRED EMBODIMENTS

<First Embodiment>

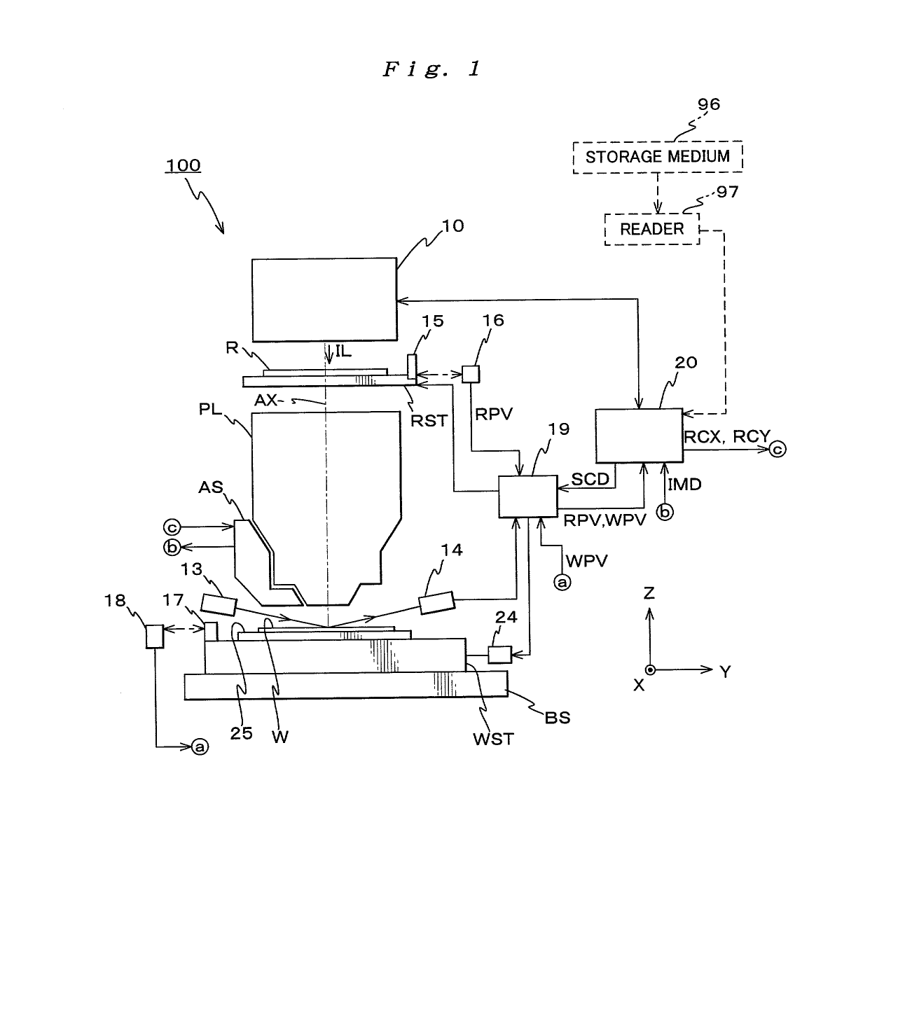

The first embodiment of the present invention will be described below with reference to FIGS. 1 to 9C.

FIG. 1 shows the schematic arrangement of an exposure apparatus 100 according to the first embodiment of the present invention. The exposure apparatus 100 is a projection exposure apparatus based on the step-and-scan method. The exposure apparatus 100 is comprised of an illumination system 10, a reticle stage RST for holding a reticle R, a projection optical system PL, a wafer stage WST on which a wafer W as a substrate (object) is mounted, an alignment microscope AS serving as a measuring unit and image pick-up unit, a main control system 20 for controlling the overall apparatus, and the like.

The illumination system 10 is comprised of a light source, an illuminance uniformization optical system constituted by a fly-eye lens and the like, a relay lens, a variable ND filter, a reticle blind, a dichroic mirror, and the like (none of which are shown). The arrangement of such an illumination system is disclosed in, for example, Japanese Patent Laid-Open No. 10-112433. This illumination system 10 illuminates a slit-like illumination area portion defined by the reticle blind above the reticle R, on which a circuit pattern and the like are drawn, with illumination light IL and with almost uniform illuminance.

The reticle R is fixed on the reticle stage RST by, for example, vacuum chucking. In order to position the reticle R, the reticle stage RST can be finely driven within the X-Y plane perpendicular to the optical axis of the illumination system 10 (which coincides with an optical axis AX of the projection optical system PL (to be described later)) by a reticle stage driving unit (not shown) formed by a magnetic levitation type two-dimensional linear actuator, and can also be driven in a predetermined scanning direction (the Y direction in this case) at a designated scanning velocity. In this embodiment, the above magnetic levitation type two-dimensional linear actuator includes a Z drive coil in addition to X and Y drive coils, and hence can finely drive the reticle stage RST in the Z direction as well.

The position of the reticle stage RST within the plane of stage movement is always detected by a reticle laser interferometer (to be referred to as a “reticle interferometer” hereinafter) 16 with, for example, a resolution of about 0.5 to 1 nm through a movable mirror 15. Position information (or velocity information) RPV of the reticle stage RST is sent from the reticle interferometer 16 to a stage control system 19. The stage control system 19 drives the reticle stage RST through the reticle stage driving unit (not shown) on the basis of the position information RPV of the reticle stage RST. Note that the position information RPV of the reticle stage RST is also sent to the main control system 20 through the stage control system 19.

The projection optical system PL is disposed below the reticle stage RST in FIG. 1 such that the direction of the optical axis AX is set as the Z-axis direction. As the projection optical system PL, a two-sided telecentric refraction optical system having a predetermined reduction magnification (e.g., ⅕ or ¼) is used. When an illumination area on the reticle R is illuminated with the illumination light IL from the illumination system 10, a reduced image (partial inverted image) of the circuit pattern on the reticle R in the illumination area is formed on the wafer W whose surface is coated with a resist (photosensitive agent) through the projection optical system PL by the illumination light IL passing through the reticle R.

The wafer stage WST is placed on a base BS below the projection optical system PL in FIG. 1. A wafer holder 25 is mounted on the wafer stage WST. The wafer W is fixed on the wafer holder 25 by, for example, vacuum chucking. The wafer holder 25 can be tilted in an arbitrary direction with respect to a plane perpendicular to the optical axis of the projection optical system PL and can also be finely driven in the direction of the optical axis AX (Z direction) of the projection optical system PL. In addition, the wafer holder 25 can be finely rotated around the optical axis AX.

The wafer stage WST is designed to move in the scanning direction (Y direction) and also move in a direction (X direction) perpendicular to the scanning direction so as to position a plurality of shot areas on the wafer W in an exposure area conjugate to the illumination area. The wafer stage WST performs step-and-scan operation, i.e., repeating scanning exposure on each shot on the wafer W and movement to the exposure start position of the next shot. The wafer stage WST is driven in an X-Y two-dimensional direction by a wafer stage driving unit 24 including a motor and the like.

The position of the wafer stage WST within the X-Y plane is always detected by a wafer laser interferometer (to be referred to as a “wafer interferometer” hereinafter) 18 with, for example, a resolution of about 0.5 to 1 nm through a movable mirror 17. Position information (or velocity information) WPV of the wafer stage WST is sent to the stage control system 19. The stage control system 19 controls the wafer stage WST on the basis of the position information WPV. Note that the position information WPV of the wafer stage WST is also sent to the main control system 20 through the stage control system 19.

The alignment microscope AS described above is an off-axis alignment sensor disposed at a side surface of the projection optical system PL. The alignment microscope AS outputs an image pick-up result on each alignment mark (wafer mark) formed in each shot area on the wafer W. Such an image pick-up result is sent as image pick-up data IMD to the main control system 20.

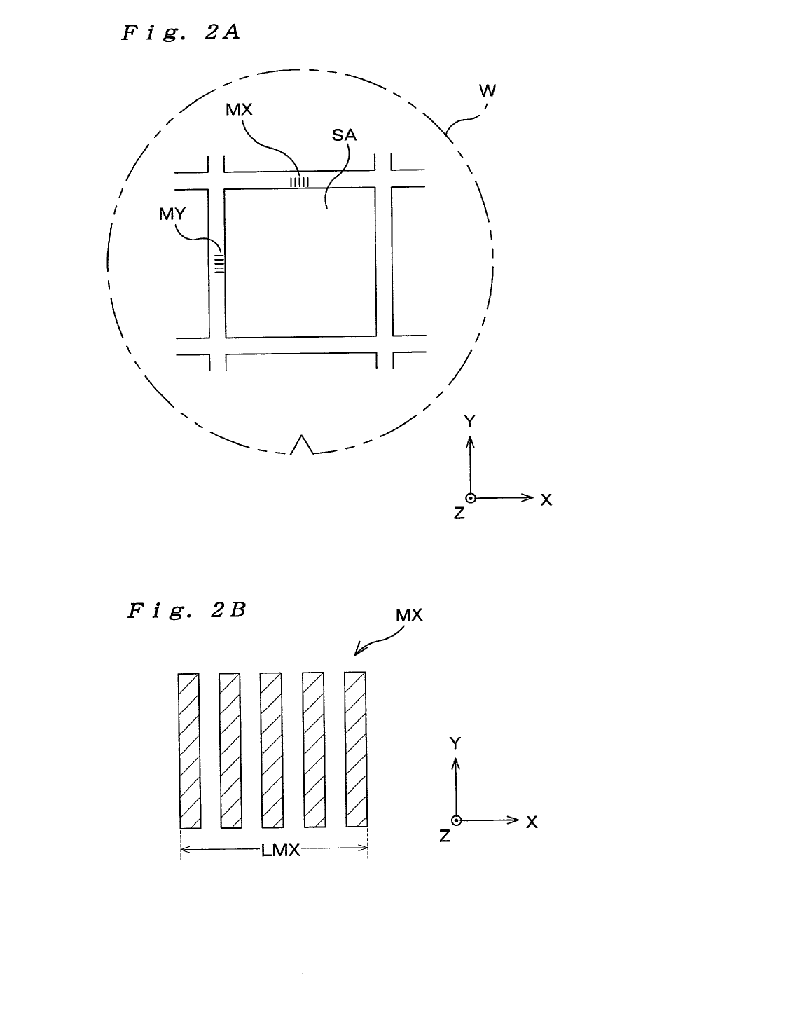

As alignment marks, X-direction position detection mark MX and Y-direction position detection mark MY serving as positioning marks are used, which are formed on street lines around a shot area SA on the wafer W as shown in, for example, FIG. 2A. As each of the marks MX and MY, a line-and-space mark having a periodic structure in a detection position direction can be used, as represented by the mark MX enlarged in FIG. 2B. The alignment microscope AS outputs the image pick-up data IMD, which is the image pick-up result, to the main control system 20 (see FIG. 1). Although the line-and-space mark shown in FIG. 2B has five lines, the number of lines of each line-and-space mark used as the mark MX (or mark MY) is not limited to five and may be any desired number. In the following description, the marks MX and MY will be individually written as marks MX(i, j) and MY(i, j) in accordance with the array position of the corresponding shot area SA.

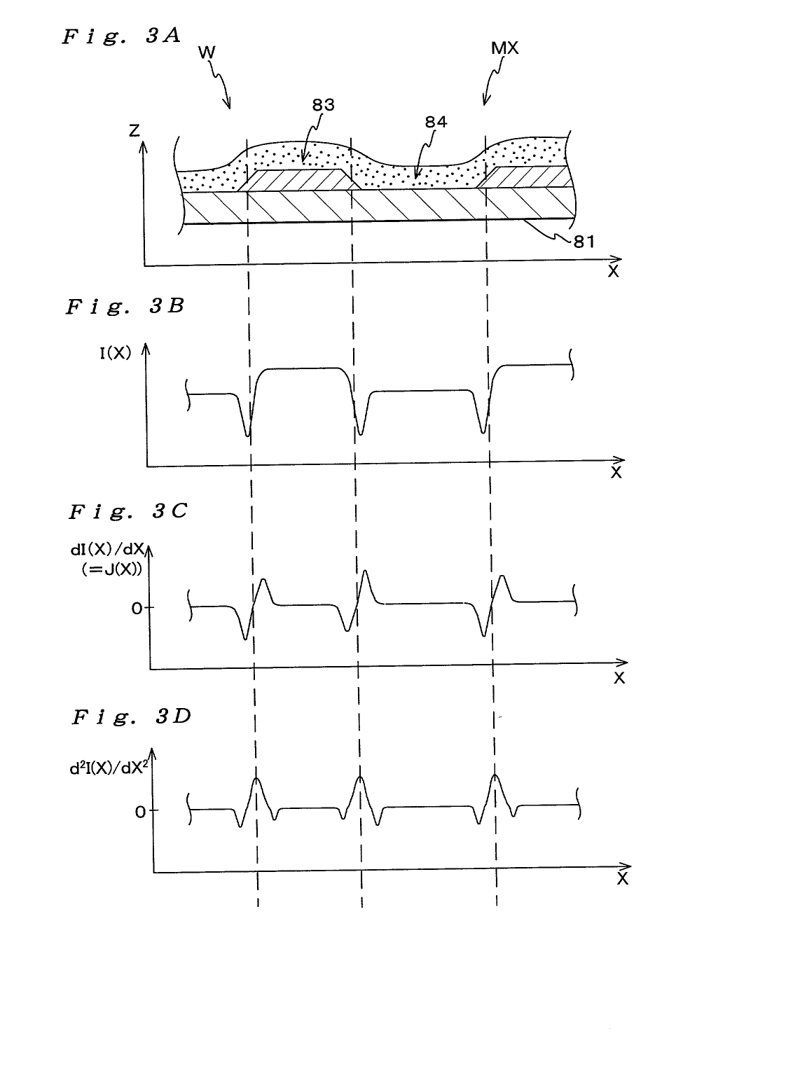

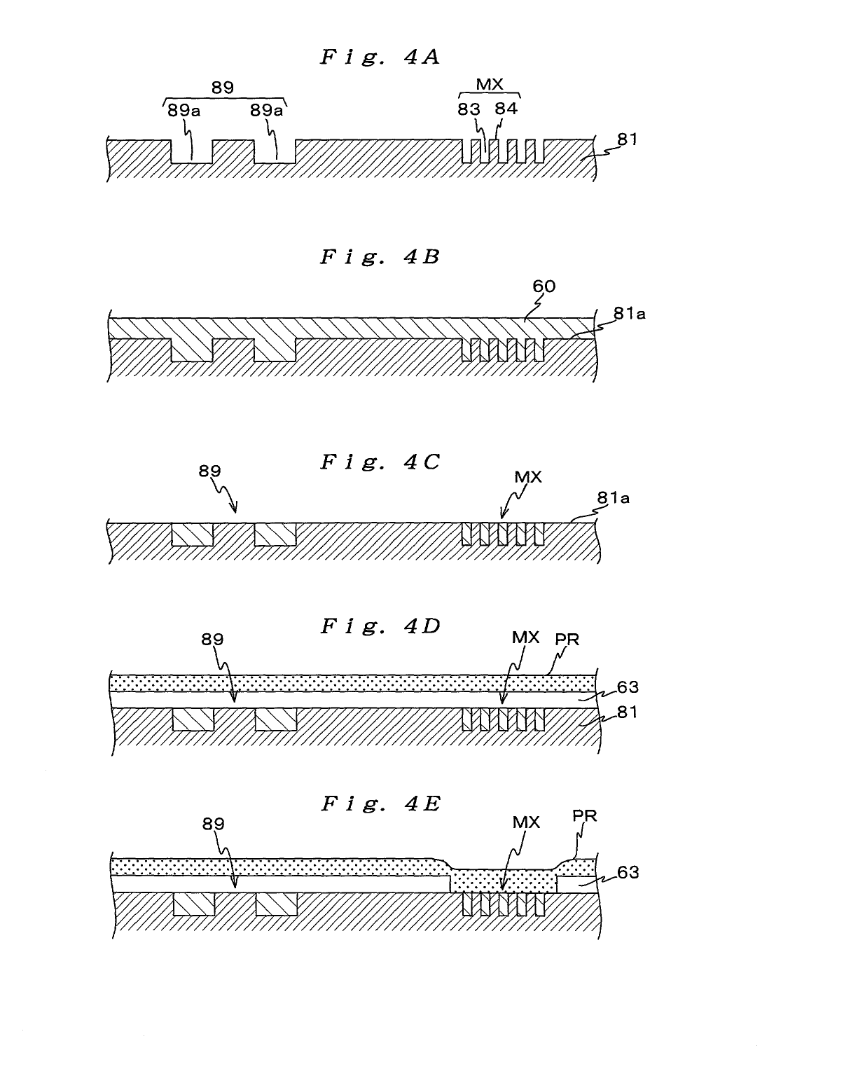

In the formation area of the mark MX on the wafer W, as indicated by an X-Z cross section in FIG. 3A, line patterns 83 and space patterns 84 are alternately formed on the upper surface of a base layer 81 in the X direction, and a resist layer covers the line patterns 83 and space patterns 84. The resist layer is made of, for example, a positive resist or chemical amplification resist and has high transparency. The base layer 81 and the line patterns 83 differ in their materials. In general, they also differ in reflectance and transmittance. In this embodiment, the line patterns 83 are made of a material having a high reflectance. The material for the base layer 81 is higher in transmittance than that for the line patterns 83. Assume that the upper surfaces of the base layer 81, line patterns 83, and space patterns 84 are almost flat.

When illumination light is applied onto the mark MX from above and a reflected light image in the formation area of the mark MX is observed from above, an X-direction light intensity distribution I(X) of the image appears as shown in FIG. 3B. More specifically, in this observation image, the light intensity is the highest and constant at a position corresponding to the upper surface of each line pattern 83, and the light intensity is the second highest and constant at a position corresponding to the upper surface of each space pattern 84 (the upper surface of the base layer 81). The light intensity changes in the form of “J” between the upper surface of the line pattern 83 and the upper surface of the base layer 81. FIGS. 3C and 3D respectively show a first-order differential waveform d(I(X))/dX (to be referred to as “J(X)” hereinafter) and second-order differential waveform d²(I(X))/dX² with respect to the signal waveform (raw waveform) shown in FIG. 3B. The position of the mark MX can be detected by using any of the above waveforms, i.e., the raw waveform I(X), first-order differential waveform J(X), and second-order differential waveform d²(I(X))/dX². In this embodiment, the first-order differential waveform J(X) is analyzed to detect the position of the mark MX.

In this differential waveform J(X), as shown in FIG. 3C, the light intensity is almost zero at positions corresponding to the upper surfaces of the line pattern 83 and space pattern 84, and greatly changes at an edge which is the boundary between the line pattern 83 and the space pattern 84. According to this change, as the phase advances from the flat portion of the upper surface of the line pattern 83 in the −X direction, a positive peak is formed first, and then a negative peak is formed. As the phase further advances in the −X direction, the light intensity becomes almost zero at a position corresponding to the upper surface of the space pattern 84. As the phase advances from the flat portion of the upper surface of the line space 83 in the +X direction, a negative peak is formed first, and then a positive peak is formed. As the phase further advances in the +X direction, the light intensity becomes almost zero at a position corresponding to the upper surface of the space pattern 84. The positive peak that appears first as the phase advances from the flat portion of the upper surface of the line pattern 83 in the −X direction will be referred to as a “peak at an inner left edge”; and the negative peak that appears next, a “peak at an outer left edge”. In addition, the negative peak that appears first as the phase advances from the flat portion of the upper surface of the line pattern 83 in the +X direction will be referred to as a “peak at an inner right edge”; and the positive peak that appears next, a “peak at an outer right edge”. In addition, the peak height value of a positive peak is a positive value, and the peak height value of a negative peak is a negative value.

Consider peak height values at an inner left edge, outer left edge, inner right edge, and outer right edge like those described above. Since the each line pattern 83 and the each space pattern 84 of one mark MX are formed simultaneously or almost simultaneously in a single process, the peak height values at edges of the same type are substantially the same within one mark MX. The relationship in magnitude between the peak height values at an inner left edge and outer right edge as positive peak portions change, and the relationship in magnitude between the peak height values at an outer left edge and inner right edge as negative peak portions also change depending on the materials for the base layer 81 and line patterns 83. In this embodiment, since the reflectance of each line pattern 83 is higher than that of the base layer 81, if the tilt of the −X-side edge (to be referred to as a “left edge”) of the line pattern 83 is almost uniform, the absolute value of the peak height at the inner left edge is larger that that at the outer left edge. If the tilt of the +X-side edge (to be referred to as a “right edge”) of the line pattern 83 is almost uniform, the absolute value of the peak height at the inner right edge is larger than that at the outer right edge. The relationship in magnitude between the absolute values of peak heights at the inner left edge and inner right edge is determined by the relationship in magnitude between the tilts of the left and right edges. If each line pattern 83 is almost symmetrical horizontally, the absolute value of the peak height at the inner left edge becomes almost equal to that at the inner right edge. In this case, the absolute value of the peak height at the outer left edge becomes almost equal to that at the outer right edge.

Note that the mark MY has the same arrangement as that of the mark MX except that the line and space patterns are arranged in the Y direction, and hence a similar signal waveform can be obtained.

Recently, with a reduction in semiconductor circuit size, a process (planarization process) of planarizing the surfaces of the respective layers on the wafer W has been used to form finer circuit patterns with higher accuracy. The best example of this process is a CMP (Chemical & Mechanical Polishing) process of planarizing the upper surface of a formed film almost perfectly by polishing the upper surface. Such a CMP process is often used for the interlayer insulating film (dielectric material such as silicon dioxide) between interconnection layers (metal) of a semiconductor integrated circuit.

In addition, recently, an STI (Shallow Trench Isolation) process has been developed, in which a shallow trench having a predetermined width is formed to insulate adjacent microdevices from each other and an insulating film such as a dielectric film is buried in the trench. In this STI process, after the upper surface of a layer in which an insulator is buried is planarized by a CMP process, a polysilicon film is also formed on the upper surface. The mark MX formed through this process will be described below with reference to FIGS. 4A to 4E by exemplifying the case wherein the mark MX and another pattern are simultaneously formed.

As indicated by the cross-sectional view of FIG. 4A, the mark MX (the recess portions corresponding to line portions 83 and space portions 84) and a circuit pattern 89 (more specifically, recess portions 89a) are formed on the silicon wafer (base) 81.

As shown in FIG. 4B, an insulating film 60 made of a dielectric material such as silicon dioxide (SiO₂) is formed on an upper surface 81a of the wafer 81. A CMP process is applied to the upper surface of the insulating film 60 to perform planarization by removing the insulating film 60 until the upper surface 81a of the wafer 81 appears, as shown in FIG. 4C. As a result, the circuit pattern 89 having the insulating film 60 buried in the recess portions 89a is formed in the circuit pattern area, and the mark MX having the insulating film 60 buried in the plurality of line portions 83 is formed in the mark MX area.

As shown in FIG. 4D, a polysilicon film 63 is formed on the upper surface 81a of the wafer 81, and the upper surface of the polysilicon film 63 is coated with a photoresist PR.

When the mark MX on the wafer 81 shown in FIG. 4D is to be observed with the alignment microscope AS, no uneven portion reflecting the mark MX formed beneath is formed on the upper surface of the polysilicon film 63. The polysilicon film 63 does not transmit a light beam in a predetermined wavelength range (visible light of 550 nm to 780 nm). For this reason, in the alignment method using visible light as alignment detection light, the mark MX may not be detected. In the alignment method in which most of detection light for alignment is occupied by visible light, the amount of light detected may decrease, and hence the detection precision may decrease.

Referring to FIG. 4D, a metal film (metal layer) 63 may be formed in place of the polysilicon film 63. In this case, no uneven portion reflecting the alignment mark formed beneath is formed on the upper surface of the polysilicon film 63. In general, since detection light for alignment is not transmitted through the metal layer, the mark MX may not be detected.

When the wafer 81 (the wafer shown in FIG. 4D) on which the polysilicon film 63 is formed through the above CMP process is to be observed with the alignment microscope AS, if the wavelength of alignment detection light can be changed (selected or arbitrarily set), the mark MX may be observed after the wavelength of alignment detection light is set to a wavelength other than that of visible light (e.g., infrared light having a wavelength in the range of about 800 nm to about 1,500 nm).

If a wavelength cannot be selected for alignment detection light or the metal layer 63 is formed on the wafer 81 after a CMP process, a portion of the metal layer 63 (or polysilicon layer 63) in an area corresponding to the mark MX may be removed by photolithography first, and then the mark MX may be observed with the alignment microscope AS.

Note that the mark MY can also be formed through a CMP process as in the case of the mark MX described above.

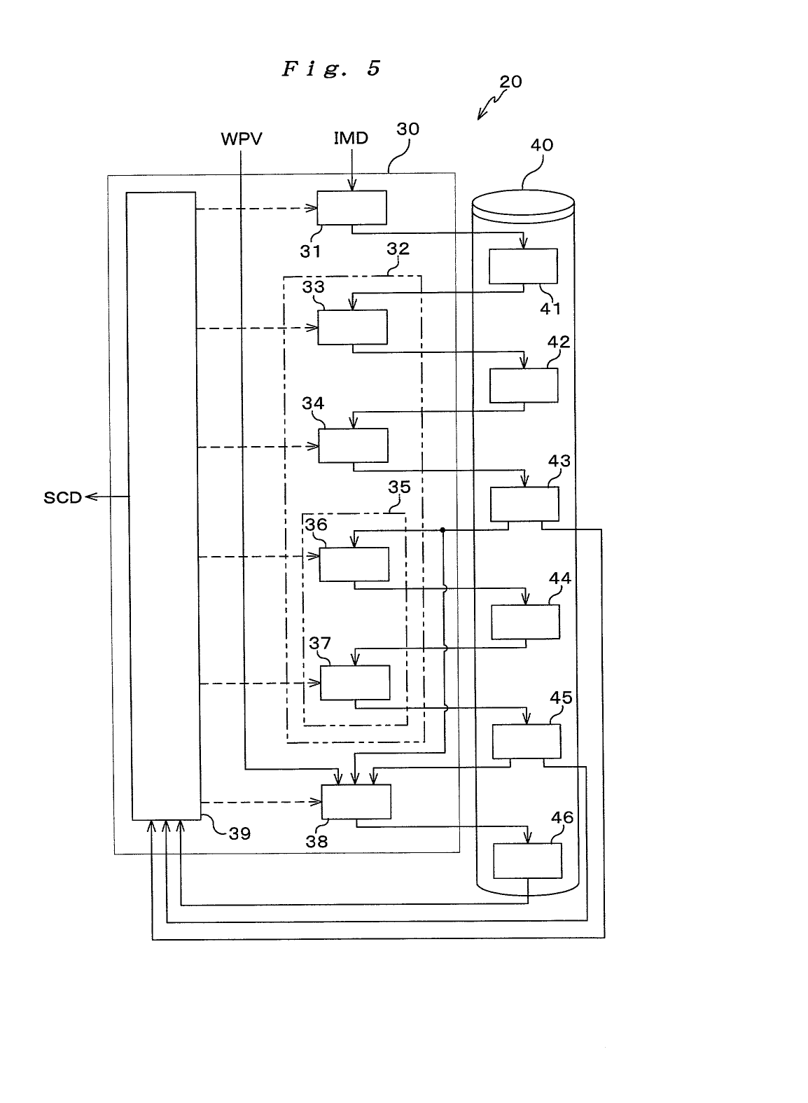

As shown in FIG. 5, the main control system 20 includes a main control unit 30 and storage unit 40.

The main control unit 30 includes a control unit 39 for controlling the operation of the exposure apparatus 100 by, for example, supplying stage control data SCD to the stage control system 19, an image pick-up data acquisition unit 31 for acquiring the image pick-up data IMD from the alignment microscope AS, a signal processing unit 32 for performing signal processing on the basis of the image pick-up data IMD acquired by the image pick-up data acquisition unit 31, and a position calculation unit 38 for calculating the positions of the marks MX and MY on the basis of the processing result obtained by the signal processing unit 32. In this case, the signal processing unit 32 includes a peak extraction unit 33 serving as an extraction unit for extracting peak position data and peak height data from the differential waveform of each signal waveform obtained from the image pick-up data IMD, a data rearrangement unit 34 for rearranging the extracted peak height data in numerical order, and a data classification unit 35 for classifying the peak height data arranged in numerical order. The data classification unit 35 includes a degree-of-randomness calculation unit 36 serving as first and second dividing units and first and second degree-of-randomness calculation units for dividing the peak height data arranged in numerical order into two groups while changing the division form and calculating the sums of degrees of randomness of the two divided data groups in each division form, and a classification calculation unit 37 serving as first and second classification units for classifying the data according to the data division form in which the sum of degrees of randomness calculated by the degree-of-randomness calculation unit 36 becomes minimum. The functions of the respective units constituting the main control unit 30 will be described later.

The storage unit 40 incorporates an image pick-up data storage area 41 for storing the image pick-up data IMD, a peak data storage area 42 for storing the peak position data and peak height data in the above differential waveform, a rearranged data storage area 43 for storing peak height data rearranged in numerical order, a degree-of-randomness storage area 44 for storing the sum of degrees of randomness in each data division form, a classification result storage area 45 for storing a data classification result, and a mark position storage area 46 for storing a mark position.

Referring to FIG. 5, the flows of data are indicated by the solid arrows, and the flows of control are indicated by the dashed arrows.

As described above, in this embodiment, the main control unit 30 is formed by a combination of various units. However, the main control unit 30 may be formed as a computer system, and the functions of the respective units constituting the main control unit 30 can be implemented by the programs stored in the main control unit 30.

If the main control system 20 is formed as a computer system, all the programs for implementing the functions of the respective units constituting the main control unit 30 need not always be stored in the main control system 20. For example, as indicated by the dotted lines in FIG. 1, a storage medium 96 may be prepared as a recording medium storing the programs, and a reader 97 which can read program contents from the storage medium 96 and allows the storage medium 96 to be detachably loaded may be connected to the main control system 20 so that the main control system 20 can read out the program contents required to implement the functions from the storage medium 96 and execute the programs.

In addition, the main control system 20 may read out program contents from the storage medium 96 loaded into the reader 97 and install them inside. Furthermore, program contents required to implement the functions may be installed from the Internet or the like into the main control system 20 through a communication network.

Note that as the storage medium 96, one of media designed to store data in various storage forms can be used, including magnetic storage media (magnetic disk, magnetic tape, etc.), electric storage media (PROM, battery-backed-up RAM, EEPROM, other semiconductor memories, etc.), magnetooptic storage media (magnetooptic disk, etc.), magnetoelectric storage media (digital audio tape (DAT), etc.), and the like.

With the above arrangement using a storage medium storing program contents for implementing the functions or designed to install the programs, correction of the program contents, upgrading for improvement in performance, and the like are facilitated.

Referring back to FIG. 1, a multiple focal position detection system based on an oblique incident light method is fixed to a support portion (not shown) of the exposure apparatus 100 which is used to support the projection optical system PL. This detection system is comprised of an irradiation optical system 13 for sending an imaging beam for forming a plurality of slit images onto the best imaging plane of the projection optical system PL from an oblique direction with respect to the direction of the optical axis AX, and a light-receiving optical system 14 for receiving the respective beams reflected by the surface of the wafer W through slits. As this multiple focal position detection system (13, 14), a system having an arrangement similar to that disclosed in, for example, Japanese Patent Laid-Open No. 6-283403 and its corresponding U.S. Pat. No. 5,448,332 is used. The stage control system 19 drives the wafer holder 25 in the Z direction and oblique direction on the basis of wafer position information from the multiple focal position detection system (13, 14). The disclosure described in the above is fully incorporated as reference herein.

In the exposure apparatus 100 having the above arrangement, the arrangement coordinates of each shot area on the wafer W are detected as follows. Assume that the arrangement coordinates of each shot area are detected on the premise that the marks MX(i, j) and MY(i, j) have already been formed on the wafer W in the process for the preceding layer (e.g., the process for the first layer). Assume also that the wafer W has been loaded onto the wafer holder 25 by a wafer loader (not shown), and coarse positioning (pre-alignment) has already been performed to allow the respective marks MX(i, j) and MY(i, j) to be set in the observation field of the alignment microscope AS when the main control system 20 moves the wafer W through the stage control system 19. This pre-alignment is performed by the main control system 20 (more specifically, the control unit 39) through the stage control system 19 on the basis of the observation of the outer shape of the wafer W, the observation results on the marks MX(i, j) and MY(i, j) in a wide field of view, and position information (or velocity information) from the wafer interferometer 18. In addition, assume that three or more X alignment marks Mx(iₚ, jₚ) (p=1 to P; P≧3) which are designed not to form one line and three or more Y alignment marks MY(i_{q}, j_{q}) (q=1 to Q: Q÷3) which are designed not to form one line, which are measured to detect the arrangement coordinates of each shot area, have already been selected. Note that the total number of marks selected (=P+Q) must be larger than six.

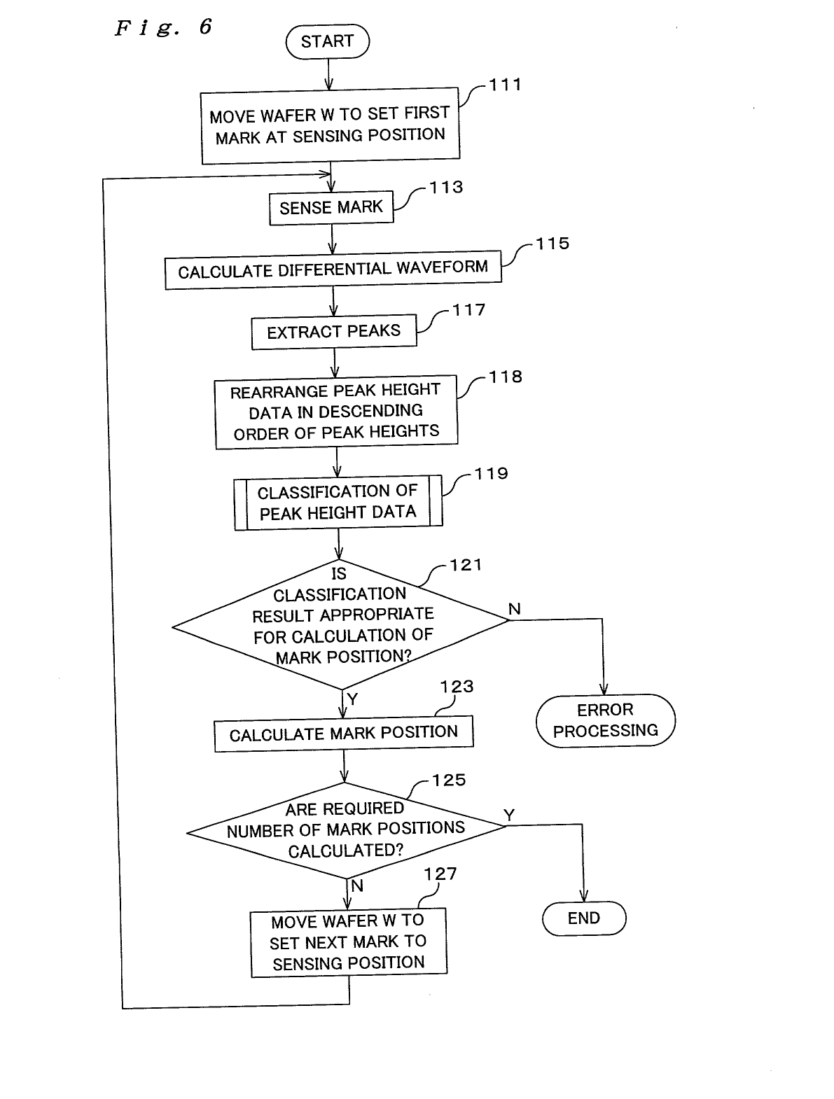

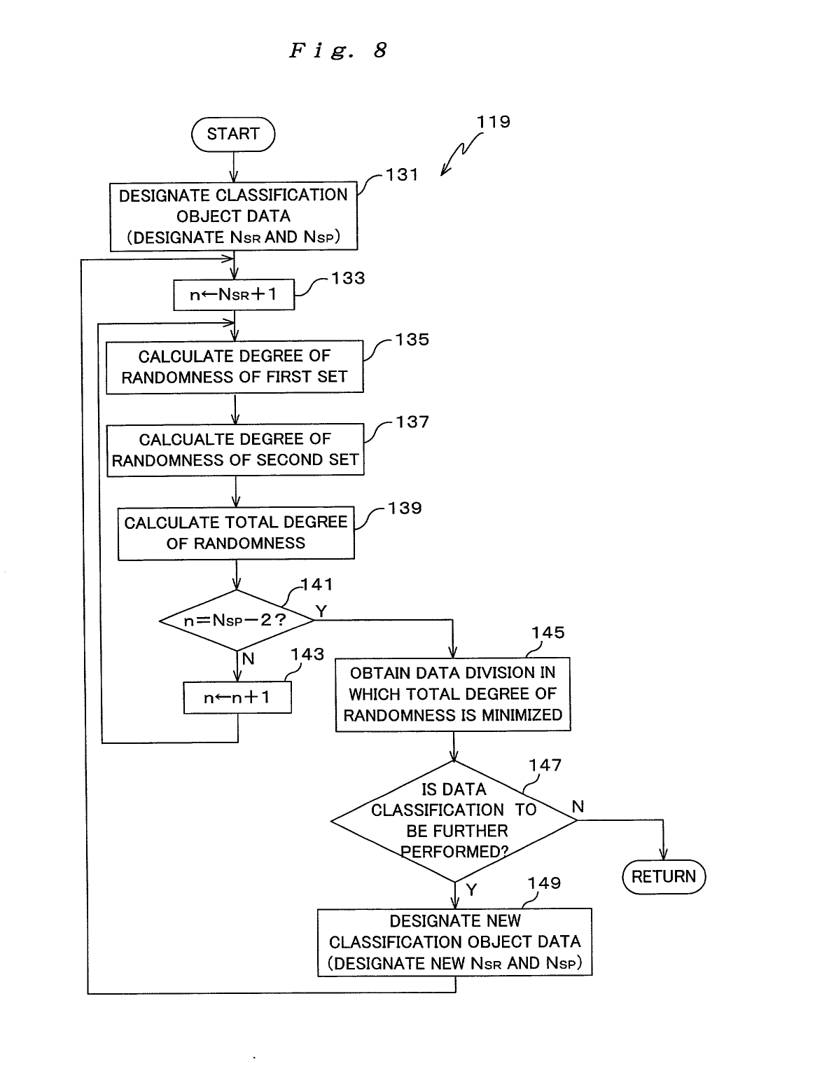

Detection of the positions of the marks MX(iₚ, jₚ) and MY(i_{q}, j_{q}) formed on the wafer W will be described below with reference to the flow charts of FIGS. 6 and 8 while other drawings are referred to as needed.

In step 111 in FIG. 6, the wafer W is moved to set the first mark (X alignment mark MX(i₁, j₁) of the selected marks MX(iₚ, jₚ) and MY(i_{q}, i_{q}) at the image pick-up position of the alignment microscope AS. This movement is performed under the control of the main control system 20 (more specifically, the control unit 39) through the stage control system 19.

In step 113, the alignment microscope AS picks up an image of the mark MX(i₁, i₁) under the control of the control unit 39. The image pick-up data acquisition unit 31 then receives the image pick-up data IMD as the image pick-up result obtained by the alignment microscope AS and stores the data in the image pick-up data storage area 41 in accordance with an instruction from the control unit 39, thereby acquiring the image pick-up data IMD.

In step 115, the peak extraction unit 33 in the signal processing unit 32 reads out the image pick-up data IMD from the image pick-up data storage area 41 and extracts signal intensity distributions (light intensity distributions) I₁(X) to I₅₀(X) on a plurality of (e.g., 50) X-direction scanning lines near a central portion of the image pick-up mark MX(i₁, j₁) in the Y direction under the control of the control unit 39. The waveform of an average signal intensity distribution in the X direction, i.e., a raw waveform I′(X), is obtained according to equation (1) given below. In the raw waveform I′(X) obtained in this manner, high-frequency noise superimposed on each of the signal intensity distributions I₁(X) to I₅₀(X) is reduced.

$${I}^{′} ( X ) = [ {\sum }_{i = 1}^{50} {I}_{i} ( X ) ] / 50 \qquad ( 1 )$$

Subsequently, the peak extraction unit 33 further removes high-frequency components by applying a smoothing technique to the waveform I′(X) calculated according to equation (1), thereby obtaining the raw waveform I(X).

The peak extraction unit 33 then differentiates the raw waveform I(X) to calculate the first-order differential waveform J(X).

In step 117, the peak extraction unit 33 extracts all peaks from the differential waveform J(X) and obtains peak data consisting of the X position and peak height of each peak. Note that in the following description, the total number of peaks extracted is represented by NT. The peak extraction unit 33 stores all extracted peak data and the value NT in the peak data storage area 42.

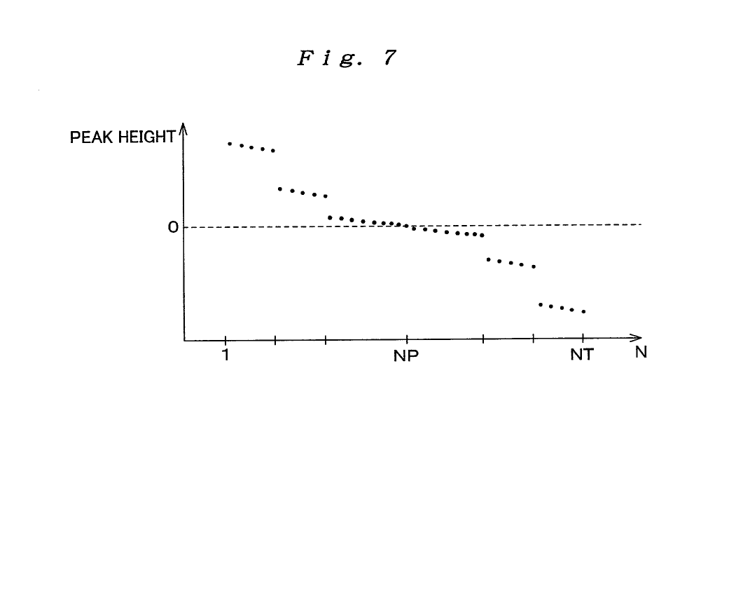

In step 118, the data rearrangement unit 34 reads out the peak data and value NT from the peak data storage area 42, rearranges the peak height data in numerical order of peak heights, and obtains a total number NP of peaks with positive peak heights under the control of the control unit 39. FIG. 7 shows an example of a graph of the peak data rearranged in this manner with the abscissa representing a peak number N (N=1 to NT) and the ordinate representing the peak height. In this graph of FIG. 7, positive peak heights include the peak at the inner left edge, the peak at the outer right edge, and noise peak, and negative peak heights include the peak at the outer left edge, the peak at the inner right edge, and noise peak. In the following description, a value of the peak height corresponding to the peak number N is represented by PH(N), and the X position corresponding to the peak number N is represented by X(N). The data rearrangement unit 34 stores the rearranged peak data, value NT, and value NP in the rearranged data storage area 43.

In subroutine 119, the data classification unit 35 classifies the peak height data under the control of the control unit 39. In this embodiment, by classifying the data in subroutine 119, candidates of peaks at the inner left edge, outer left edge, inner right edge, and outer right edge, which are signal peaks, are obtained.

In subroutine 119, in step 131 in FIG. 8, the control unit 39 reads out the values NT and NP from the rearranged data storage area 43. To perform first classification of peaks having positive peak heights, of a string of peaks arranged in numerical order of peak heights, which include the peak at the inner left edge and the peak at the outer right edge, i.e., the first peak to the NPth peak, the control unit 39 sets a start peak number N_{SR} of classification object data to 1 and an end peak number N_{SP} to the value NP. The control unit 39 designates the start peak number N_{SR} (=1) and end peak number N_{SP} (=NP) for the degree-of-randomness calculation unit 36 of the data classification unit 35.

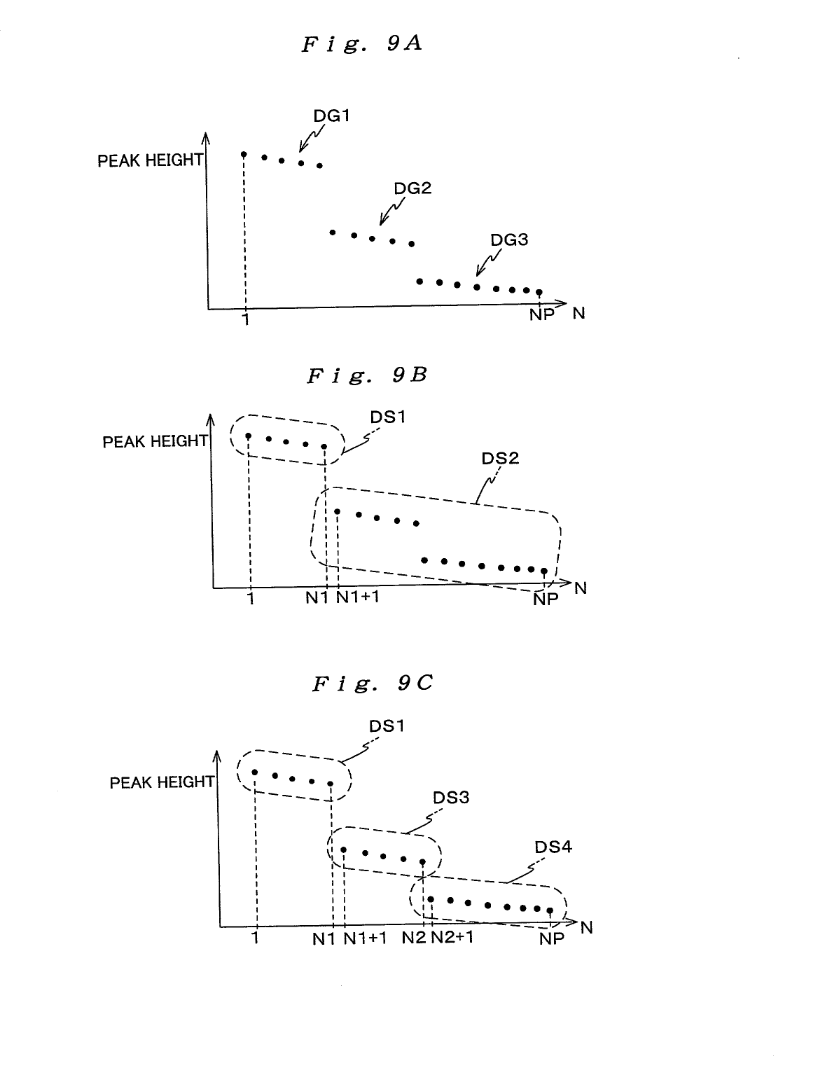

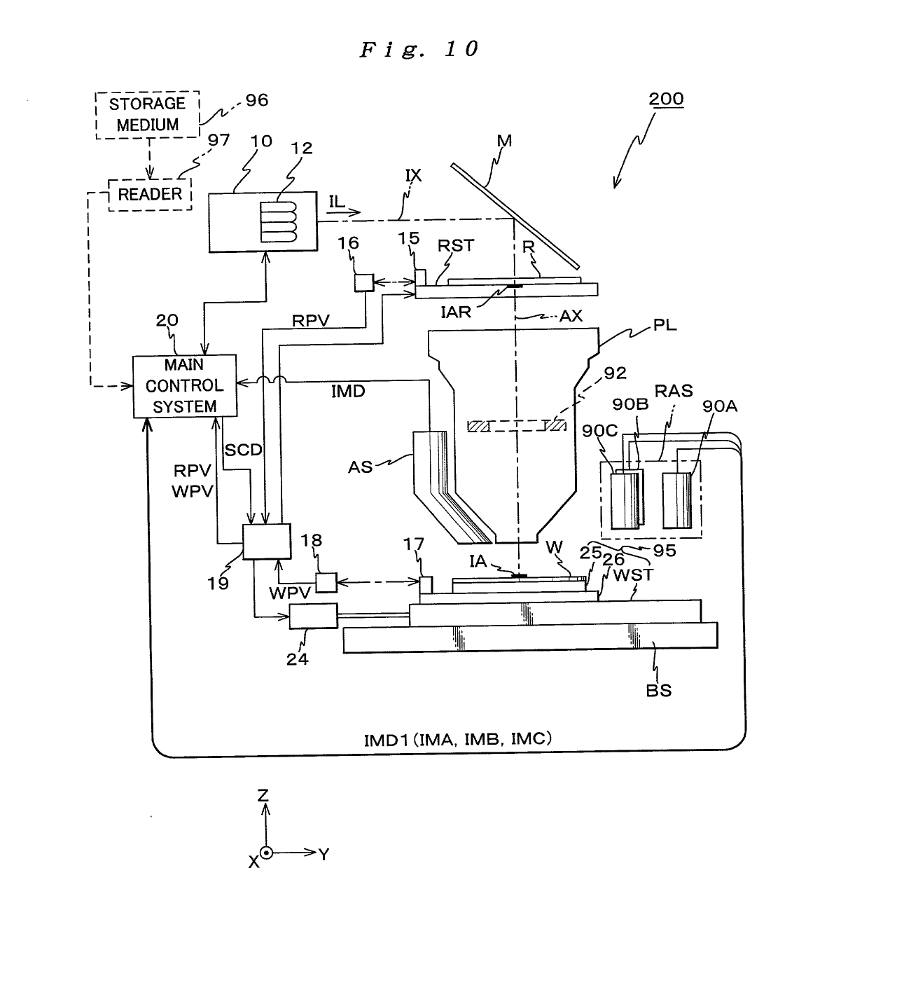

Upon designation of the start peak number N_{SR} and end peak number N_{SP} by the control unit 39, in step 133, the degree-of-randomness calculation unit 36 sets a division parameter n to an initial value (N_{SR}+1), and reads out pulse height data PH(N_{SR}) to PH(N_{SP}) from the rearranged data storage area 43. FIG. 9A shows an example of a graph of the pulse height data PH(N_{SR}) to PH(N_{SP}) read out in this manner, with the abscissa representing the peak number N (N=1 to NT) and the ordinate representing the peak height as in FIG. 7. In the case shown in FIG. 9A, three data groups exist, namely a peak height data group DG1 corresponding to the inner left edge, a peak height data group DG2 corresponding to the outer right edge, and a noise peak height data group DG3. In the following positive peak height data classification, the positive peak height data are classified into candidates of the three data groups, namely the peak height data group DG1 corresponding to the inner left edge, the peak height data group DG2 corresponding to the outer right edge, and the noise peak height data group DG3.

In step 135, the degree-of-randomness calculation unit 36 calculates a degree S1ₙ of randomness of the pulse height data in the first set consisting of the pulse height data PH (N_{SR}) to PH(n).

In calculating the degree S1ₙ of randomness, first of all, the degree-of-randomness calculation unit 36 estimates a probability density function F1ₙ(t) of the pulse height data by using a continuous variable t representing the pulse height. If an average value μ1ₙ and standard deviation σ1ₙ are respectively given by

$$\begin{matrix}{μ1}_{n} = [ {\sum }_{j = {N}_{SR}}^{n} ( PH ( j ) ) ] / ( n - {N}_{SR} + 1 ) & ( 2 ) \\ {σ1}_{n} = [ {\sum }_{j = {N}_{SR}}^{n} {( PH ( j ) - {μ1}_{r} )}^{2} ] / ( n - {N}_{SR} ) & ( 3 )\end{matrix}$$

then, this probability density function F1ₙ(t) is estimated as a normal distribution given by

$${F1}_{n} ( t ) = \frac{1}{\sqrt{2 π} \cdot {σ1}_{n}} exp [ \frac{{( t - {μ1}_{n} )}^{2}}{2 {( {σ1}_{n} )}^{2}} ] \qquad ( 4 )$$

Subsequently, the degree-of-randomness calculation unit 36 calculates an entropy E1ₙ of the probability density function F1n(t) by

$$\begin{matrix}{E1}_{n} = - {\int }_{- ∞}^{∞} [ ( {F1}_{n} ( t ) ) \cdot Ln [ {F1}_{n} ( t ) ] ] ⅆ t \\ = Ln ( \sqrt{2 π} \cdot {σ1}_{n} ) + \frac{1}{2}\end{matrix} \qquad ( 5 )$$

In this specification, symbol“Ln(X)” means the natural logarithm of value X.

With a weighting factor W1ₙ given by

W1ₙ=(n−N_{SR}+1)/(N_{SP}−N_{SR}+1) (6)

the degree-of-randomness calculation unit 36 calculates the degree S1ₙ of randomness of the pulse height data in the first set by

S1ₙ=W1ₙ·E1ₙ (7)

In step 137, the degree-of-randomness calculation unit 36 calculates a degree S2ₙ of randomness of the pulse height data in a second set consisting of the pulse height data PH (n+1) to PH (N_{SP}).

In calculating the degree S2ₙ of randomness, as in the case of the calculation of the degree S1ₙ of randomness, first of all, the degree-of-randomness calculation unit 36 estimates a probability density function F2ₙ(t) of the pulse height data by using the continuous variable t representing the pulse height. If an average value μ2ₙ and standard deviation σ2ₙ are respectively given by

$$\begin{matrix}{μ2}_{n} = [ {\sum }_{j = n + 1}^{{N}_{SP}} ( PH ( j ) ) ] / ( {N}_{SP} - n ) & ( 8 ) \\ {σ2}_{n} = [ {\sum }_{j = n + 1}^{{N}_{SP}} {( PH ( j ) - {μ2}_{n} )}^{2} ] / ( {N}_{SP} - n - 1 ) & ( 9 )\end{matrix}$$

then, this probability density function F2n(t) is estimated as a normal distribution given by

$${F2}_{n} = \frac{1}{\sqrt{2 π} \cdot {σ2}_{n}} exp [ \frac{{( t - {μ2}_{n} )}^{2}}{2 {( {σ2}_{n} )}^{2}} ] \qquad ( 10 )$$

Subsequently, the degree-of-randomness calculation unit 36 calculates an entropy E2ₙ of the probability density function F2n(t) by

$$\begin{matrix}{E2}_{n} = - {\int }_{- ∞}^{∞} [ ( {F2}_{n} ( t ) ) \cdot Ln [ {F2}_{n} ( t ) ] ] ⅆ t \\ = Ln ( \sqrt{2 π} \cdot {σ2}_{n} ) + \frac{1}{2}\end{matrix} \qquad ( 11 )$$

With a weighting factor W2ₙ given by

W2ₙ=(N_{SP}−n)/(N_{SP}−N_{SR}+1) (12)

the degree-of-randomness calculation unit 36 calculates the degree S2ₙ of randomness of the pulse height data in the second set by

S2ₙ=W2ₙ·E2ₙ (13)

In step 139, the degree-of-randomness calculation unit 36 obtains a total degree Sₙ of randomness of the pulse height data PH (N_{SR}) to PH(N_{SP}) for the division parameter n by calculating the sum of the degree S1ₙ of randomness the first set and the degree S2ₙ of randomness of the second set. That is, the total degree Sₙ of randomness is according to

Sₙ=S1ₙ+S2ₙ (14)

The degree-of-randomness calculation unit 36 then stores the calculated total degree Sₙ of randomness in the degree-of-randomness storage area 44.

In step 141, the degree-of-randomness calculation unit 36 checks whether the pulse height data PH(N_{SR}) to PH(N_{SP}) have undergone all division forms, i.e., whether the division parameter n becomes a value (N_{SP}−2). In this case, since only the degree of randomness in the first division form is calculated, NO is obtained in step 141, and the flow advances to step 143.

In step 143, the degree-of-randomness calculation unit 36 increments the division parameter n (n→n+1) to update the division parameter n. Subsequently, steps 135 to 143 are executed to calculate the total degree Sₙ of randomness with each division parameter n in the above manner until the division parameter n takes a value (N_{SP}−2) and the pulse height data PH(N_{SR}) to PH(N_{SP}) undergo all division forms. The calculated data are then stored in the degree-of-randomness storage area 44. If YES is obtained in step 141, the flow advances to step 145.

In step 145, under the control of the control unit 39, the classification calculation unit 37 reads out the total degrees Sₙ (n=(N_{SR}+1) to (N_{SP}−2) of randomness from the degree-of-randomness storage area 44 and obtains a division parameter value N1 with which the minimum total degree Sₙ of randomness is obtained. The division parameter value N1 obtained in this manner indicates the number of the peak that exhibits the minimum peak height in the peak height data group DG1 corresponding to the inner left edge in the pulse height distribution in the case shown in FIG. 9A. In data classification with the division parameter value N1, as shown in FIG. 9B, the data are classified into a data set DS1 consisting of peak candidates at the inner left edge and a data set DS2 ` consisting of the remaining peaks. The classification calculation unit 37 stores the division parameter value N1 having the above meaning in the classification result storage area 45.

In step 147, the control unit 39 checks whether to further perform data classification. In this step, since only the first data classification is performed for the positive peak height data to classify the data into the two data sets DS1 and DS2, NO is obtained. The flow then advances to step 149.

In step 149, the control unit 39 reads out the division parameter value N1 from the classification result storage area 45 and determines the type of classification performed from the value N1. In this case, the control unit 39 determines that the data have been classified into the data set DS1 consisting of the peak candidates at the inner left edge and the data set DS2 consisting of the remaining peaks, and the data set DS2 is a new classification object. The control unit 39 then sets the new start peak number N_{SR} of the classification object data to (N1+1) and also sets the new end peak number N_{SP} to a value NP. The control unit 39 designates the start peak number N_{SR} and end peak number N_{SR} for the degree-of-randomness calculation unit 36 of the data classification unit 35.

Subsequently, as in the first data classification, steps 133 to 145 are executed to obtain a division parameter value N2 with which the peak height data PH(N1+1) to PH(NP) in the data set DS2 are classified, and are stored in the classification result storage area 45. The division parameter value N2 obtained in this manner indicates the number of the peak that exhibits the minimum peak height in the peak height data group DG2 corresponding to the outer right edge in the pulse height distribution in the case shown in FIG. 9A. In data classification using the division parameter value N2, as shown in FIG. 9C, the data are classified into a data set DS3 consisting of peak candidates at the outer right edge and a data set DS4 consisting of the remaining peaks.

After the above processing, in step 147 again, the control unit 39 checks whether to further perform data classification. In this step, since only the data classification is performed for the positive peak height data to classify the data, NO is obtained, and the flow advances to step 149.

In step 149, to classify negative peak height data, the control unit 39 sets the new start peak number N_{SR} of classification object data to (NP+1) and also sets the new end peak number N_{SP} to the value NT. The control unit 39 designates the start peak number N_{SR} and end peak number N_{SP} for the degree-of-randomness calculation unit 36 of the data classification unit 35.

Subsequently, as in the classification of the positive peak height data, the negative peak height data are classified to obtain division parameters N3 and N4 with which peak candidates at the inner right edge and peak candidates at the outer left edge are classified, and are stored in the classification result storage area 45.

When data classification of both the positive peak height data and the negate peak height data is completed in this manner, NO is obtained in step 147, and the processing in subroutine 119 is completed. The flow then advances to step 121 in FIG. 6.

In step 121, the control unit 39 reads out the values N1 to N4 from the classification result storage area 45 and obtains the respective numbers of peak candidates at the inner left edge, outer left edge, inner right edge, and outer right edge from these values. The control unit 39 then checks whether the number of peak candidates at each edge coincides with an expected value, i.e., the number (five in this embodiment) of line patterns 83 of the mark MX(i₁, j₁), thereby checking whether proper classification is performed for the detection of the X position of the mark MX(i₁, j₁). In this case, if each of the numbers of peak candidates at the respective edges coincides with the expected value, YES is obtained in step 121, and the flow advances to step 123.

If at least one of the numbers of peak candidates at the respective edges differs from the expected value, NO is obtained in step 121, and the flow advances to error processing. In this embodiment, in the error processing, a mark MX(i₁′, j₁′) is selected as an alternative to the mark MX(i₁, j₁). After the mark MX(i₁′, i₁′) of the wafer W is moved to the image pick-up position, steps 111 to 119 are executed, and the peaks obtained from the image pick-up result on the mark MX(i₁′, j₁′) are classified as in the case of the mark MX(i₁, i₁). As in step 121, it is checked whether proper classification has been performed for the detection of the X position of the mark MX(i₁′, j₁′). If NO is obtained in step 121, it is determined that mark detection on the wafer W cannot be performed, and exposure processing for the wafer W is stopped. If YES is obtained in step 121, the flow advances to step 123.

In step 123, the position calculation unit 38 reads out the values N1 to N4 from the classification result storage area 45 and specifies the peak numbers of peaks, as signal peaks, at the inner left edge, outer left edge, inner right edge, and outer right edge. The position calculation unit 38 then reads out the X positions of the peaks of the specified peak numbers from the rearranged data storage area 43, and obtains the X positions of the respective edges on the basis of the readout X positions of the peaks and the X position information (or velocity information) WPV of the wafer W which is supplied from the wafer interferometer 18. The position calculation unit 38 then obtains the average of these edge positions to calculate the X positions of the mark MX(i₁, i₁) and mark MX(i₁′, i₁′). Thereafter, the position calculation unit 38 stores the obtained positions of the mark MX(i₁, j₁) and mark MX(i₁′, j₁′) in the mark position storage area 46.

In step 125, it is checked whether the positions of a necessary number of marks are completely calculated. In the above case, since only the calculation of the X positions of the mark MX(i₁, i₁) or mark MX(i₁′, j₁′) is completed, NO is obtained in step 125, and the flow advances to step 127.

In step 127, the control unit 39 moves the wafer W to a position where the next mark comes into the image pick-up field of the alignment microscope AS. To move the wafer W in this manner, the control unit 39 controls the wafer stage driving unit 24 through the stage control system 19 to move the wafer stage WST.

Subsequently, the X positions of the marks MX(iₚ, jₚ) or marks MX(iₚ′, jₚ′) (p=2 to p) and the Y positions of the marks MY(i_{q}, j_{q}) or marks MY(i_{q}′, j_{q}′) (q=1 to N) are calculated until it is determined in step 125 that the required number of mark positions are calculated, as in the case of the mark MX (i₁, j₁) or mark MX(i₁′, j₁′).

In this manner, the required number of mark positions are calculated and stored in the mark position storage area 46, and the mark position detection is terminated.

Subsequently, the control unit 39 reads out the X positions of the marks MX(iₚ, jₚ) (p=1 to P) and the Y positions of the marks MY(i_{q}, j_{q}) (q=1 to Q) from the mark position storage area 46 and calculates a parameter (error parameter) value for calculating the arrangement coordinates of each shot area SA. Such a parameter is calculated by using a statistical technique such as EGA (Enhanced Global Alignment) disclosed in Japanese Patent Laid-Open No. 61-44429 and its corresponding U.S. Pat. No. 4,780,617. The disclosure described in the above is fully incorporated as reference herein.

In this manner, the calculation of the parameter for calculating the arrangement coordinates of each shot area SA is completed.

When the parameter value for calculating the arrangement coordinates of each shot area SA is calculated in the above manner, the control unit 39 sends the stage control data SCD to the stage control system 19 while using the shot area arrangement obtained by using the calculated parameter value. The stage control system 19 then synchronously moves the reticle R and wafer W through the reticle driving unit (not shown) and the wafer stage WST, while referring to the stage control data SCD, on the basis of the X-Y position information of the reticle R measured by the reticle interferometer 16 and the X-Y position information of the wafer W measured in the above manner.

During this synchronous movement, the reticle R is illuminated with a slit-like illumination area having a longitudinal direction in a direction perpendicular to the scanning direction of the reticle R. In exposure operation, the reticle R is scanned at a velocity V_{R}, and the illumination area (whose center almost coincides with the optical axis AX) is projected on the wafer W through the projection optical system PL to form a slit-like projection area, i.e., exposure area, conjugate to the illumination area. Since the wafer W and reticle R have an inverted image relationship, the wafer W is scanned in a direction opposite to the direction of the velocity V_{R} at a velocity V_{W} in synchronism with the reticle R. The entire surface of the shot area SA on the wafer W can be exposed. A ratio V_{W}/V_{R} of the scanning velocities accurately corresponds to the reduction magnification of the projection optical system PL. The pattern on each pattern area on the reticle R is accurately reduced/transferred onto the corresponding shot area on the wafer W. The width of each illumination area in the longitudinal direction is set to be larger than the corresponding pattern area on the reticle R and smaller than the maximum width of a light-shielding area. This makes it possible to illuminate the entire pattern area by scanning the reticle R.

When a reticle pattern is completely transferred onto one shot area by scanning exposure controlled in the above manner, the wafer stage WST is stepped to perform scanning exposure for the next shot area. In this manner, stepping operation and scanning exposure operation are sequentially repeated to transfer patterns onto the wafer W the necessary number of shots times.

As described above, according to this embodiment, peaks corresponding to the inner left edge, outer left edge, inner right edge, and outer right edge are classified according to the degrees of randomness of the peak height data of peaks in the signal waveform obtained from image pick-up results on the marks MX and MY such that the degrees of randomness are minimized, thereby specifying peaks. Since the positions of the marks MX and MY are obtained by using the peak positions of the specified peaks, mark positions can be automatically detected with high precision even if the form of noise superimposed is unknown. In this embodiment, the arrangement coordinates of the shot area SA(i, j) on the wafer W are calculated on the basis of the accurately obtained positions of the alignment marks MX and MY, and the wafer W can be positioned with high precision on the basis of the calculation result. This makes it possible to accurately transfer each pattern formed on the reticle R onto the corresponding shot area SA(i, j).

In this embodiment, if data classification is performed once and the resultant resolution is not sufficient, peak data, of the data set subjected to the preceding data classification, which require further classification are further subjected to data classification. This makes it possible to automatically and rationally obtain signal data candidates with a desired resolution.

In this embodiment, in classifying the peak height data of peaks in the signal waveform obtained from the image pick-up results on the marks MX and MY, data division is performed in numerical order of data values, and the degree of randomness of each data division is calculated. This makes it possible to quickly classify the peak height data.

In this embodiment, in calculating degrees of randomness, a probability density function is estimated for each data set obtained by dividing the peak height data obtained from the image pick-up results on the marks MX and MY, the entropy of each probability density function is obtained, and a weight corresponding to the number of data belonging to each data set is assigned, thereby obtaining a statistically rational degree of randomness of data values.

In addition, since a probability distribution is estimated as a normal distribution, a rational probability density function can be estimated.

Furthermore, the validity of classification is determined by checking whether the number of data belonging to each classified set after classification of peak height data coincides with an expected value, and the positions of the marks MX and MY are detected only when the validity is determined. This makes it possible to prevent errors in mark position detection and accurately detect mark positions.

The exposure apparatus 100 of this embodiment is manufactured as follows. The respective components shown in FIG. 1 described above are mechanically, optically, and electrically combined with each other. Thereafter, overall adjustment (electrical adjustment, operation check, and the like) is performed on the resultant structure. Note that the exposure apparatus 100 is preferably manufactured in a clean room in which temperature, cleanliness, and the like are controlled.

In the embodiment described above, the positions of the marks MX and MY are detected by classifying peak height data with peaks (extreme points) in the first-order differential waveform of a raw waveform being set as feature points. However, points of inflection in the first-order differential waveform may be set as feature points, and values quantitatively representing the features of the feature points may be classified as data to detect the positions of the marks MX and MY. Furthermore, the positions of the marks MX and MY can be detected by setting extreme points or points of inflection in the second- or higher-order differential waveform of a raw waveform as feature points and classifying values quantitatively representing the features of the feature points as data.

The embodiment described above has exemplified the so-called double mark that allows observation of inner and outer edges between line and space patterns. However, the present invention can be applied to a so-called single mark that allows observation of only one edge between line and space patterns. In this case, since it suffices if each of positive peak height data and negative peak height data in a first-order differential waveform is divided into two data sets, when the apparatus of the above embodiment is to be used, each of the positive peak height data and negative peak height data may be classified once.

In the embodiment described above, line-and-space marks are used. Obviously, marks in other shapes can also be used.

In the above embodiment, peak height data values are arranged in numerical order, and the total degrees of randomness in all division forms of the peak height data values in numerical order are calculated to obtain a division form in which the degree of randomness is minimized. When data are to be classified into two data sets from which degrees of randomness are to be obtained, a division form in which the degree of randomness is minimized can be obtained by the so-called hill-climbing method such as the simplex method using a total degree of randomness as an evaluation function. In this case, the number of division forms in which degrees of randomness are to be calculated can be decreased.

In the embodiment described above, in classifying each of positive peak height data and negative peak height data into three classification sets, classification into two classification sets is performed twice by using one division parameter. However, data can also be classified into three classification sets at once by a method using two division parameters. For example, the present invention can use a technique of setting as an evaluation function a total degree of randomness which is the sum of degrees of randomness of three data sets determined by two division parameters and obtaining a division form in which the total degree of randomness is minimized in the two-dimensional space defined by the two division parameters by using the so-called hill-climbing method such as the simplex method.

In the above embodiment, in classifying each of positive peak height data and negative peak height data into three classification sets, one of data sets classified by the first classification is set as a object for the second data classification on the basis of the number of data. However, after two data sets classified by the first classification as objects are classified into four data sets in total, a combination of the four data sets with which the total degree of randomness is minimized when the data are classified into three classification sets may be obtained, and therefore the data can be classified into three classification sets.

Data can also be classified into four or more classification sets, as needed. In this case, classification into two classification sets may be repeatedly performed or classification may be performed at once by the so-called hill-climbing method using a plurality of division parameters.

<<Second Embodiment>>

The second embodiment of the present invention will be described below with reference to FIGS. 10 to 23.

The present invention can also be applied to a case wherein a boundary portion (e.g., outer shape) of an object to be picked up is extracted on the basis of an image pick-up result on the object. For example, the present invention can be used when a substrate such as a wafer or glass plate (to be generically referred to as a “wafer” hereinafter) is picked up, and the outer shape of the wafer is extracted.

In this embodiment, the present invention is applied to a case wherein the outer shape of a wafer is extracted to detect the position of the wafer. In describing this embodiment, the same reference numerals as in the first embodiment denote the same or equivalent parts, and a repetitive description will be avoided.

FIG. 10 is a view showing the schematic arrangement of an exposure apparatus 200 according to the second embodiment. The exposure apparatus 200 in FIG. 10 is a projection exposure apparatus based on the step-and-scan scheme like the exposure apparatus of the first embodiment.

The exposure apparatus 200 includes an illumination system 10, a reticle stage RST, a projection optical system PL, a wafer stage unit 95 serving as a stage unit having a wafer stage WST serving as a stage that moves in an X-Y two-dimensional direction within the X-Y plane while holding a wafer W, a rough alignment detection system RAS serving as an image pick-up unit for picking up an image of the outer shape of the wafer W, an alignment detection system AS, and a control system 20 for these components.

A substrate table 26 is placed on the wafer stage WST. A wafer holder 25 is mounted on the substrate table 26. The wafer holder 25 holds the wafer W by vacuum chucking. Note that the wafer stage WST, substrate table 26, and wafer holder 25 constitute the wafer stage unit 95.

The illumination system 10 is comprised of a light source unit, a shutter, a secondary source forming optical system having a fly-eye lens 12, a beam splitter, a condenser lens system, a reticle blind, an imaging lens system, and the like (no components other than the fly-eye lens 12 are shown). The arrangement and the like of this illumination system 10 are disclosed in, for example, Japanese Patent Laid-Open No. 9-320956. As this light source unit, one of the following light sources is used: an excimer laser light source such as a KrF excimer laser source (oscillation wavelength: 248 nm) or ArF excimer laser source (oscillation wavelength: 193 nm), F₂ excimer laser source (oscillation wavelength: 157 nm), Ar₂ laser source (oscillation wavelength: 126 nm), copper vapor laser source or YAG laser harmonic generator, ultra-high pressure mercury lamp (e.g., a g line or i line), and the like.

The function of the illumination system 10 having this arrangement will be briefly described below. Illumination light emitted from the light source unit strikes the secondary source forming optical system when the shutter is open. As a consequence, many secondary sources are formed at the exit end of the secondary source forming optical system. Luminance light emerging from these secondary sources reaches the reticle blind through the beam splitter and condenser lens system. The illumination light passing through the reticle blind emerges toward a mirror M through the imaging lens system.

The optical path of illumination light IL is bent vertically by the mirror M afterward to illuminate a rectangular illumination area IAR on a reticle R held on the reticle stage RST

The projection optical system PL is held on a main body column (not shown) below the reticle R such that the optical axis direction of the system is set as a vertical axis (Z-axis) direction, and is made up of a plurality of lens elements (refraction optical elements) arranged at predetermined intervals in the vertical axis direction (optical axis direction) and a lens barrel holding these lens elements. The pupil plane of this projection optical system is conjugate to the secondary source plane and is in the relation of Fourier transform with the surface of the reticle R. An aperture stop 92 is disposed near the pupil plane, and the numerical aperture (N.A.) of the projection optical system PL can be arbitrarily adjusted by changing the size of the aperture of the aperture stop 92. As the aperture stop 92, an iris is used, and the numerical aperture of the projection optical system PL can be changed within a predetermined range by changing the aperture diameter of the aperture stop 92 by a stop driving mechanism (not shown). The stop driving mechanism is controlled by the main control system 20.

Diffracted light passing through the aperture stop 92 contributes to the formation of an image on the wafer W located conjugate to the reticle R.

A pattern image on the illumination area IAR on the reticle R illuminated with the illumination light in the above manner is projected on the wafer W at a predetermined projection magnification (e.g., ¼ or ⅕) through the projection optical system PL, thereby forming a reduced image (partial inverted image) of the pattern on the exposure area IA on the wafer W.

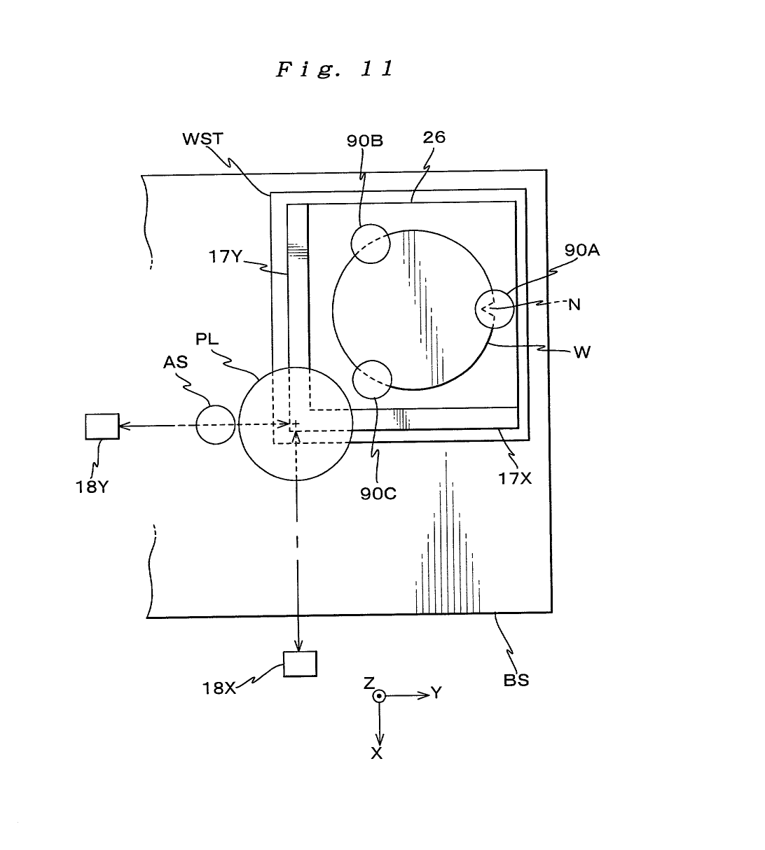

The rough alignment detection system RAS is held by a holding member (not shown) at a position away from the projection optical system PL above a base station apparatus. This rough alignment detection system RAS has three rough alignment sensors 90A, 90B, and 90C for detecting the positions of three portions of the peripheral portion of the wafer W held by the wafer holder 25 which is transported by a wafer loader (not shown). As shown in FIG. 11, these three rough alignment sensors 90A, 90B, and 90C are arranged at intervals of 120° (central angle) on a circumference with a predetermined radius (nearly equal to the radius of the wafer W). One of these sensors, the rough alignment sensor 90A in this case, is disposed at a position where a notch N (V-shaped notch) of the wafer W held on the wafer holder 25 can be detected. As these rough alignment sensors, sensors based on an image processing scheme are used, each of which is comprised of an image pick-up unit and image processing circuit. Referring back to FIG. 10, image pick-up result data IMD1 on the periphery of the wafer W which is obtained by the rough alignment detection system RAS is supplied to the main control system 20. Note that the image pick-up result data IMD1 is made up of image pick-up result data IMA obtained by the rough alignment sensor 90A, image pick-up result data IMB obtained by the rough alignment sensor 90B, and image pick-up result data IMC obtained by the rough alignment sensor 90C.

The exposure apparatus 200 also has a multiple focal position detection system as one of focus detection systems based on the oblique incident light scheme, which detect the position of a portion in the exposure area IA (the area on the wafer W which is conjugate to the illumination area IAR described above) on the wafer W and its neighboring area in the Z direction (the direction of the optical axis AX). Note that this multiple focal position detection system has the same arrangement as that of the multiple focal position detection system (13, 14) in the first embodiment described above.

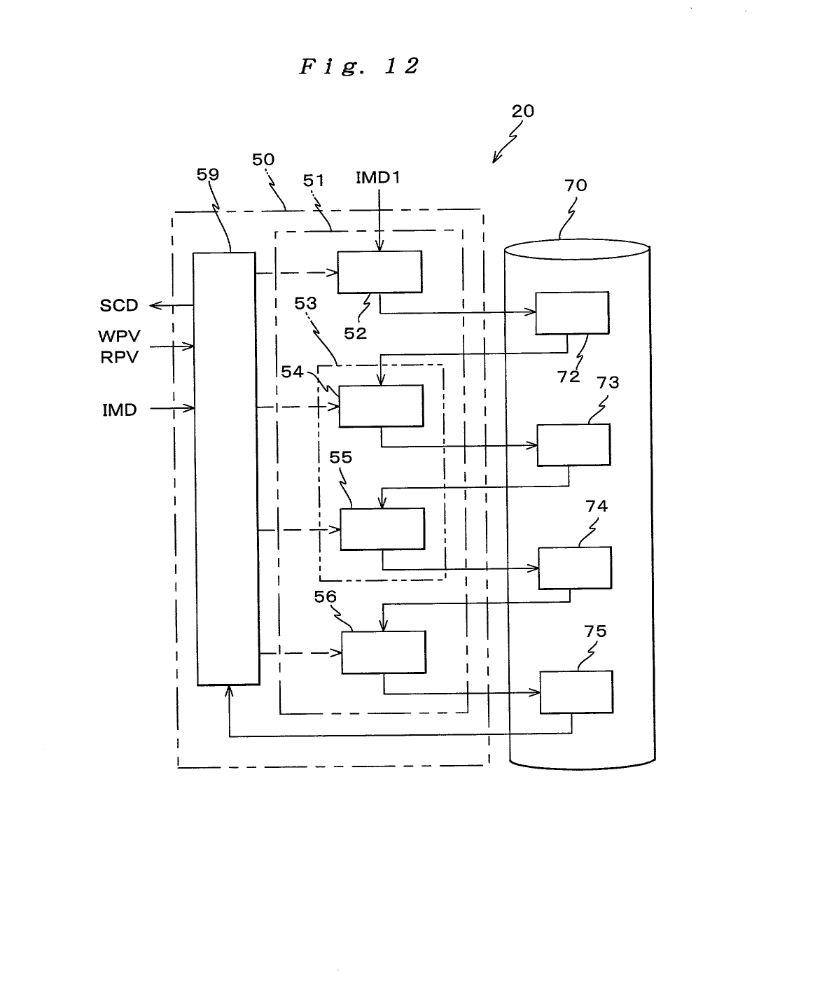

As shown in FIG. 12, the main control system 20 includes a main control unit 50 and storage unit 70. The main control unit 50 has (a) a control unit 59 for controlling the overall operation of the exposure apparatus 200 by, for example, supplying stage control data SCD to a stage control system 19 on the basis of position information (velocity information) RPV of the reticle R and position information (velocity information) of the wafer W, and (b) a wafer outer shape calculation unit 51 for measuring the outer shape of the wafer W and detecting the central position and radius of the wafer W on the basis of the image pick-up result data IMD1 supplied from the rough alignment detection system RAS. The wafer outer shape calculation unit 51 includes (i) an image pick-up data acquisition unit 52 for acquiring the image pick-up result data IMD1 supplied from the rough alignment detection system RAS, (ii) an image processing unit 53 for performing image processing for the image pick-up data acquired by the image pick-up data acquisition unit 52, and (iii) a parameter calculation unit 56 for calculating the central position and radius of the wafer W as shape parameters for the wafer W on the basis of the image processing result obtained by the image processing unit 53.

The image processing unit 53 has (i) a processed data generation unit 54 for generating processed data (a histogram corresponding to luminances, a probability distribution, differential values corresponding to the positions of luminances, or the like) on the basis of the image data of each pixel (the luminance information of each pixel), and (ii) a boundary estimation unit 55 for analyzing an obtained processed data distribution and estimating the boundary (or threshold) between a wafer image and a background image.

The storage unit 70 incorporates an image pick-up data storage area 72, texture feature value storage area 73, estimated boundary position storage area 74, and measurement result storage area 75.

Referring to FIG. 12, the flows of data are indicated by the solid arrows, and the flows of control are indicated by the dashed arrows. The function of each component of the main control system 20 having the above arrangement will be described later.

As described above, in this embodiment, the main control unit 50 is formed by a combination of various units. However, the main control system 20 may be formed as a computer system, and the functions of the respective units constituting the main control unit 50 can be implemented by the programs stored in the main control system 20.

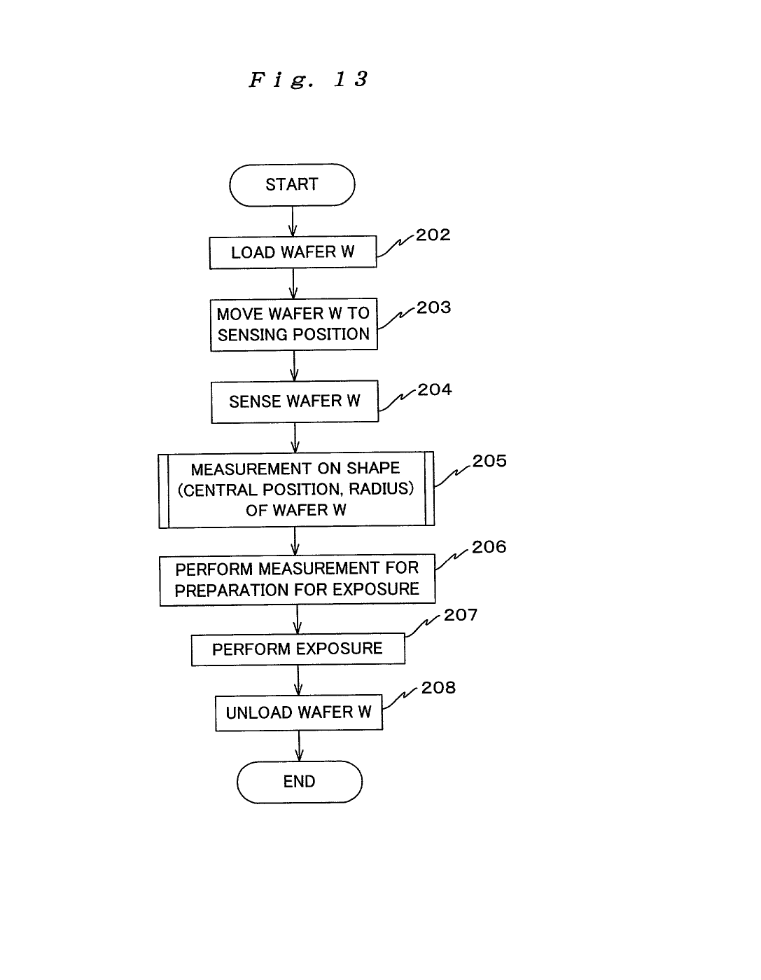

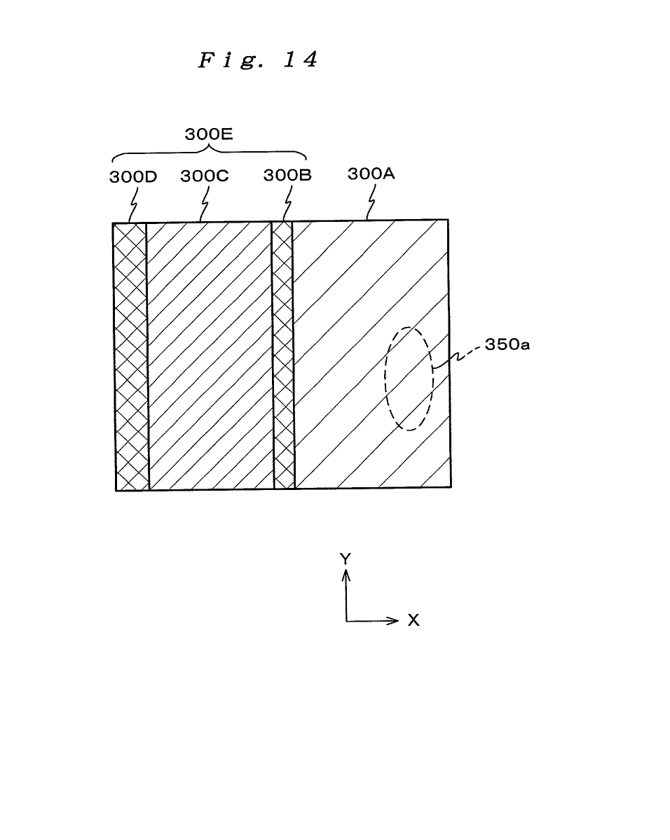

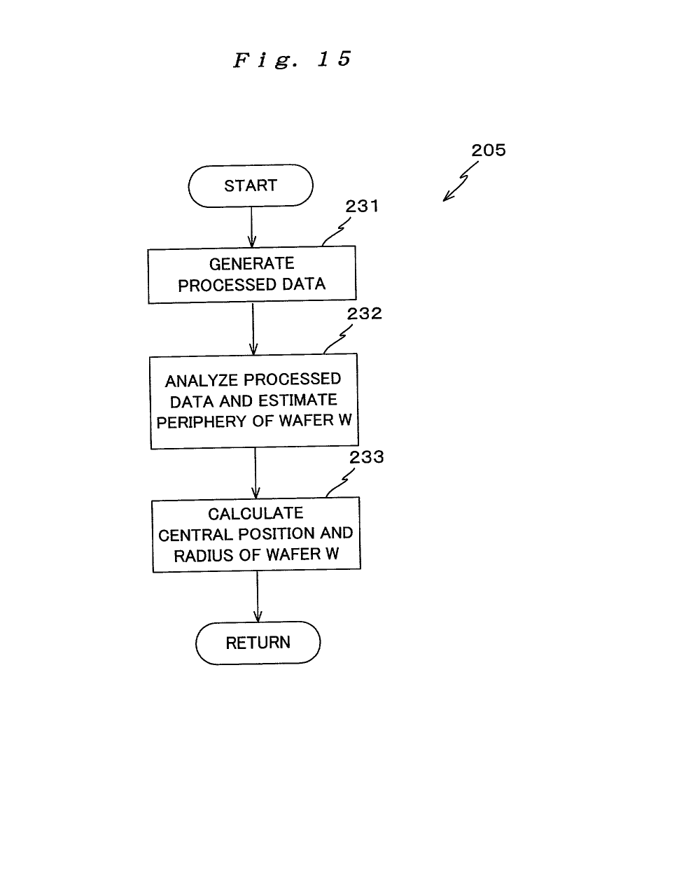

Exposure operation by the exposure apparatus 200 of this embodiment will be described below with reference to the flow chart of FIG. 13 while other drawings are referred to as needed.

In step 202, the reticle R on which a transferred pattern is formed is loaded onto the reticle stage RST by a reticle loader (not shown). The wafer W to be exposed is loaded onto the substrate table 26 by a wafer loader (not shown).

In step 203, the wafer W is moved to the position where it is picked up by the rough alignment sensors 90A, 90B, and 90C. This movement is performed by the main control system 20 (more specifically, the control unit 59 (see FIG. 12)), which moves the substrate table 26 through the stage control system 19 and a stage driving unit 24 to roughly position the wafer W such that the notch N of the wafer W is located immediately below the rough alignment sensor 90A, and the periphery of the wafer W is located immediately below the rough alignment sensors 90B and 90C.

Subsequently, in step 204, the rough alignment sensors 90A, 90B, and 90C respectively pick up portions near the periphery of the wafer W.

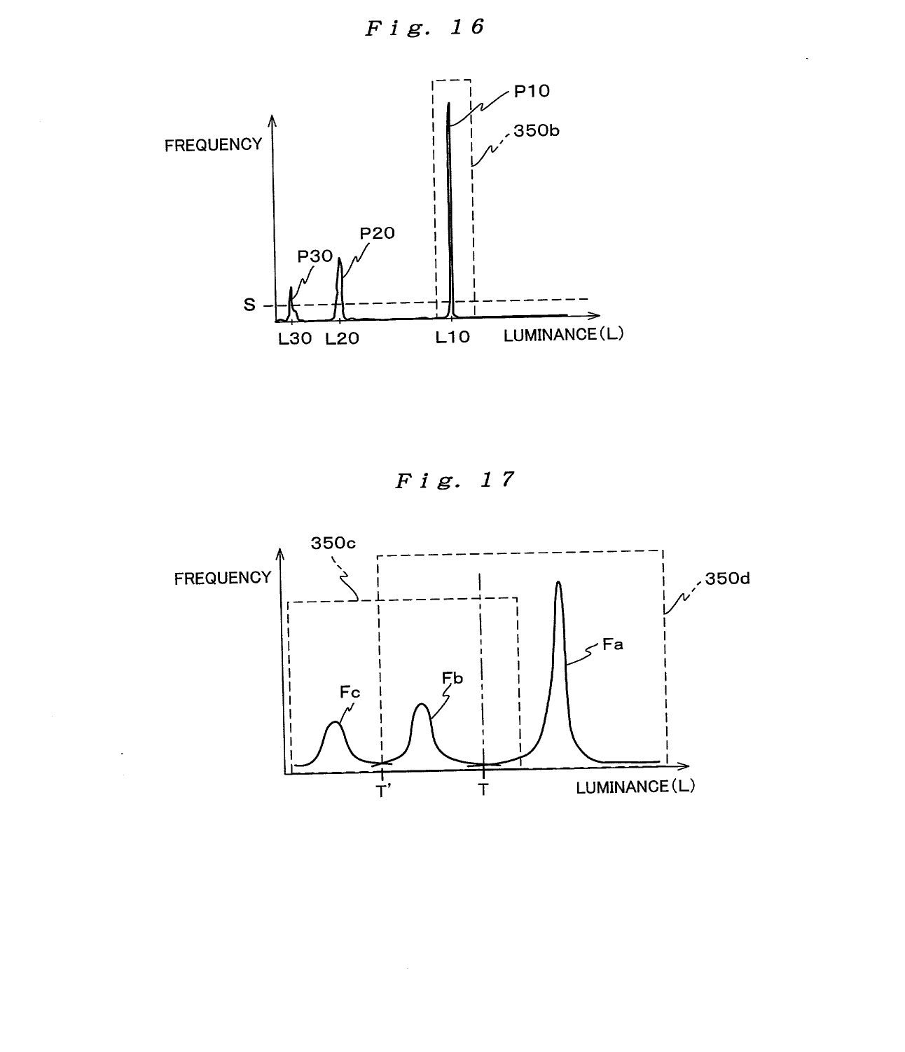

FIG. 14 shows an example of the image pick-up result obtained by picking up portions near the periphery of a wafer (glass wafer) made of a glass material (e.g., gallium arsenide glass) using these three rough alignment sensors 90A, 90B, and 90C. As shown in FIG. 14, a background area (an area outside the wafer W) 300A has nearly uniform brightness. An image 300E of the wafer W includes an area 300B darker than the background area 300A, an area 300C which is darker than the background area 300A but brighter than the area 300B, and an area 300D having brightness nearly equal to that of the area 300B.

The image pick-up result obtained by the rough alignment sensors 90A, 90B, and 90C is supplied as the image pick-up result data IMD1 to the main control system 20. In the main control system 20, the image pick-up data acquisition unit 52 receives the image pick-up result data IMD1 and stores the received data in the image pick-up data storage area 72.

Referring back to FIG. 13, in subroutine 205, the shape of the wafer W, i.e., a central position Qw and radius Rw as shape parameters for the wafer W, is measured. FIG. 15 shows the contents of subroutine 205. In subroutine 205, first of all, predetermined processing is performed for the image pick-up result data IMD1 to generate predetermined processed data in step 231 in FIG. 15. The generated processed data may include, for example, frequency distribution (histogram) data generated on the basis of the luminance values of the respective pixels of the image pick-up unit, probability distribution data generated on the basis of the luminance values of the respective pixels, and processed data generated by, for example, filtering the image pick-up result data IMD1 (for example, differential waveform data about the X position of luminance, which is generated after differential filtering is performed as processing).

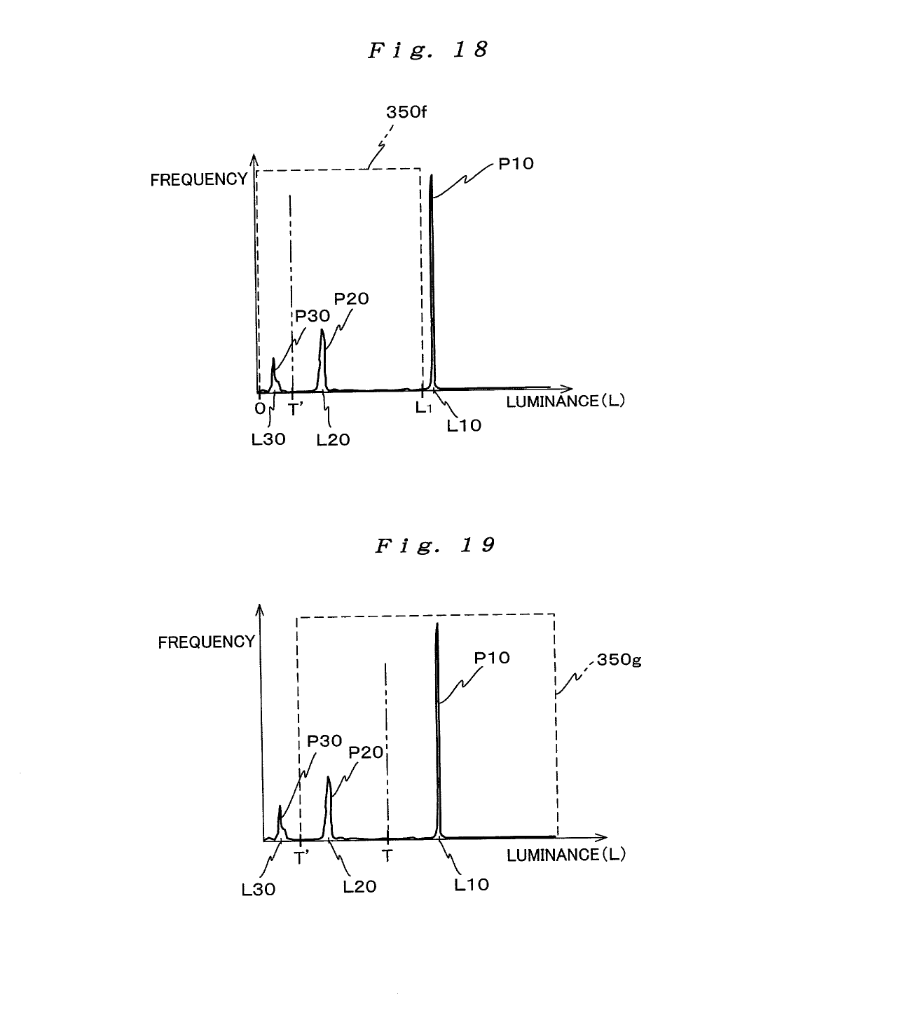

FIG. 16 shows the above frequency distribution data. As shown in FIG. 16, the frequency distribution of the luminance values of the respective pixels, obtained from the image pick-up result data IMD1, has three peaks P10, P20, and P30.

FIG. 17 shows the above probability distribution data. As shown in FIG. 17, the probability distribution data of the luminance values of the respective pixels becomes a probability distribution including three normal distribution states.

The above differential waveform data is generated by applying a differential filter to the image data in FIG. 14. As a result, differential waveform data 320 is obtained, which is waveform data based on the absolute values of the first-order differential values of image data distribution waveform data (to be referred to as a “luminance waveform” hereinafter) 310 along the X direction in FIG. 21.

Subsequently, the processed data generation unit 54 stores the processed data generated in the above manner (at least one of the processed data described above) in a processed data storage area 73. The processing in step 231 is completed in this manner.

In step 232, the boundary (threshold, contour, or outer shape) estimation unit 55 reads out desired (one or a plurality of types) processed data from the processed data storage area 73. The boundary between the wafer image and the background is then estimated (the contour or outer shape of the wafer is estimated) by performing data analysis or the like using one of the following boundary estimation techniques.

<First Boundary Estimation Technique>

In the first boundary estimation technique, the boundary between a wafer image and a background is estimated by obtaining a luminance (i.e., a threshold T) corresponding to a boundary value at which the sum total of degrees of randomness (entropy) is minimized as in the first embodiment using the histogram data (luminance distribution data) shown in FIG. 16. Note that this technique has already been described in detail in the embodiment described above, and hence will be briefly described below.

First of all, the boundary estimation unit 55 samples luminance data about pixels in an area that can be obviously regarded as a background (e.g., an are 350a enclosed with the dotted line frame in FIG. 14) from the image. By this sampling, the boundary estimation unit 55 estimates the luminance distribution (dotted line area 350b in FIG. 16) of the background image in the image pick-up data.

In a portion (a dotted line area 350f in FIG. 18) with luminance lower than that in the confidence interval in the luminance distribution, a likelihood “temporary threshold (luminance value) T′” for dividing the distribution into two luminance distributions is calculated from the luminance distribution of the estimated background image by using the first maximum likelihood method to be described next. Note that the above confidence interval is obtained in advance on the basis of an experimental or simulation result.

This first maximum likelihood method uses a total degree Sₙ of randomness (entropy) as described in step 119 in FIGS. 6 and 8.

The boundary estimation unit 55 calculates a degree S1ₙ of randomness of the data values in the first set consisting of luminance data ranging from a luminance value L(0) to an arbitrary luminance value L(n). In calculating this degree S1ₙ of randomness, the boundary estimation unit 55 estimates a probability density function F1ₙ(t) associated with the occurrence probability of the luminance data by setting the luminance value L as a continuous variable t. Subsequently, the boundary estimation unit 55 calculates an entropy E1ₙ of the probability density function F1ₙ(t) by using equation (5) given above. The boundary estimation unit 55 then obtains a weighting factor by using equation (6) given above and calculates the degree S1ₙ of randomness of the luminance value data in the first set by using equation (7) given above.

The boundary estimation unit 55 calculates a degree S2ₙ of randomness of the data in the second set consisting of the luminance data after L(n+1) in the area 350f by using equations (10) to (13) given above in the same manner as described above. The boundary estimation unit 55 then obtains the total degree Sₙ of randomness by calculating the sum of the degree S1ₙ of randomness and degree S2ₙ of randomness obtained above.

Subsequently, the boundary estimation unit 55 calculates the total degrees Sₙ of randomness in all division forms in the area 350f by repeating the above processing while changing a division parameter n. Upon calculating the degrees Sₙ of randomness in all the division forms, the boundary estimation unit 55 obtains a division parameter value (temporary parameter value) T′ as a luminance value with which the minimum one of the total degrees Sₙ of randomness is obtained.

The boundary estimation unit 55 then calculates a likelihood parameter value (luminance value) T again, which is used to divide the distribution into two distributions, from the calculated temporary parameter value (luminance value) T′ with respect to only an area 350g on the luminance distribution side of the background image area by using the above first maximum likelihood method. This obtained division parameter value (luminance value) T becomes the “threshold T (luminance value)” for determining the boundary between the wafer image and the background image.

According to the first boundary estimation technique, the threshold T (luminance value) for determining the boundary between a wafer image and a background image is estimated in the above manner.

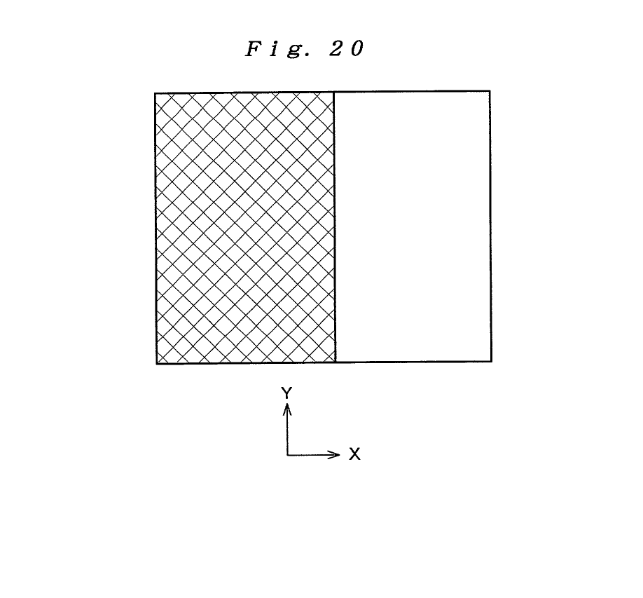

The boundary estimation unit 55 binarizes the image pick-up result data IMD1 on the basis of the estimated threshold T (for example, each pixel, in the image pick-up unit, from which a luminance value is larger than the threshold T is expressed as “white”, whereas each pixel from which a luminance value is equal to or less than the threshold T is expressed as “black”). FIG. 20 shows the image binarized with the threshold T. The periphery of the actual wafer is accurately estimated on the basis of this binarized image data. Referring to FIG. 20, the “black” area is indicated by cross-hatching.

The boundary estimation unit 55 stores, for example, the estimated boundary position (X-Y coordinate position) calculated on the basis of the binary image and the above threshold T or the binary image (see FIG. 20) data itself in the estimated boundary position storage area 74.

<Second Boundary Estimation Technique>

According to the second estimation technique, the boundary between a wafer image and a background is estimated by using the histogram data (luminance distribution data) shown in FIG. 16 and the probability distribution data shown in FIG. 17.

First of all, as in the first boundary estimation technique, the boundary estimation unit 55 samples luminance data about pixels in an area that can be obviously regarded as a background (e.g., the area 350a enclosed with the dotted line frame in FIG. 14) from the image. By this sampling, the boundary estimation unit 55 estimates the luminance distribution (dotted line area 350b in FIG. 16) of the background image in the image pick-up data. In the portion (the dotted line area 350f in FIG. 18) with luminance lower than that in the confidence interval in the luminance distribution, the likelihood “temporary threshold (luminance value) T′” for dividing the distribution into two luminance distributions is calculated from the luminance distribution of the estimated background image by using the second maximum likelihood method to be described next.

In the second maximum likelihood method, the point of intersection of probability distributions is obtained as the maximum likelihood point as a boundary point by using the probability distribution data in FIG. 17. More specifically, the point of intersection of a probability distribution Fb and probability distribution Fc existing in an area 350c in FIG. 17 is obtained, and the luminance value at this point of intersection is set as the temporary parameter value (luminance value) T′.

The boundary estimation unit 55 then calculates the likelihood parameter value (luminance value) T again, which is used to divide the distribution into two distributions, from the calculated temporary parameter value (luminance value) T′ with respect to only an area 350d on the luminance distribution side of the background image area shown in FIG. 17 by using the above second maximum likelihood method. That is, the boundary estimation unit 55 obtains the point of intersection of a probability distribution Fa and a probability distribution Fb existing in the area 350d, and sets the luminance value at the point of intersection as the parameter value (luminance value) T. The parameter value (luminance value) T obtained in this manner becomes the “threshold T (luminance value)” for determining the boundary between the wafer image and the background image.

According to the second boundary estimation technique, the boundary (threshold T) between a wafer image and a background is estimated in the above manner.

The boundary estimation unit 55 then binarizes the image pick-up result data IMD1 on the basis of the threshold T to estimate the periphery of the wafer as in the first boundary estimation technique described above. The boundary estimation unit 55 stores the calculated estimated boundary position, threshold T, binarized image, and the like in the estimated boundary position storage area 74.

<Third Boundary Estimation Technique>

In the third estimation technique, the boundary between a wafer image and a background is estimated by obtaining the threshold T with which the inter-class variance is maximized by using the histogram data (luminance distribution data) shown in FIG. 16. The inter-class variance will be briefly described. Consider a case wherein a given universal set (luminance data) is divided into two classes (first and second subsets) by a given threshold T. In this case, the square of the difference between the average value of the universal set and the average value of the first subset and the square of the difference between the average value of the universal set and the average value of the second subset are respectively weighted by probabilities, and the sum of the resultant values is obtained.

First of all, the boundary estimation unit 55 samples luminance data about pixels in an area that can be obviously regarded as a background (e.g., the area 350a enclosed with the dotted line frame in FIG. 14) from the image, and estimates the luminance distribution (the dotted line area 350b in FIG. 16) of the background in the image pick-up data.

In the portion (the dotted line area 350f in FIG. 18) with luminance lower than that in the confidence interval in the luminance distribution described above, the likelihood “temporary parameter value (luminance value) T′” for dividing the distribution into two distributions, with which the inter-class variance is maximized, is calculated from the luminance distribution of the estimated background in the following manner.

First of all, the boundary estimation unit 55 calculates a probability distribution Pi and all average luminance values μ_{T} of the image in the area 350 (luminance values 0 to L₁) according to equations (15) and (16) given below. Note that “N” represents the total number of pixels (the total number of data) within the dotted line frame in FIG. 18, and “ni” represents the number of pixels having a luminance value i.

Pi=ni/N (15)

$${μ}_{T} = ( 1 / N ) \cdot [ {\sum }_{i = 0}^{{L}_{1}} ( i \cdot ni ) ] = {\sum }_{i = 0}^{{L}_{1}} ( i \cdot Pi ) \qquad ( 16 )$$

The boundary estimation unit 55 then divides the data (luminance values 0 to L₁) in the area 350f into two classes (sets) C₁ and C₂ by setting an unknown threshold (luminance value) as “k”. In this case, a probability density ω(k) and average value μ(k) up to the luminance value k are respectively expressed by equations (17) and (18) given below. Note that ω(L₁)=1 and μ(L₁)=μ_{T}.

$$\begin{matrix}ω ( k ) = {\sum }_{i = 0}^{k} Pi & ( 17 ) \\ μ ( k ) = {\sum }_{i = 0}^{l} ( i \cdot Pi ) & ( 18 )\end{matrix}$$

Average values μ₁ and μ₂ of the respective classes C₁ and C₂ are respectively calculated by

$$\begin{matrix}{μ}_{1} = {\sum }_{ⅈ ∈ {S}_{1}} \{ i \cdot [ {P}_{r} ( i \vert {C}_{1} ) ] \} , {S}_{1} = [ 0 , … , k ] & ( 19 ) \\ {μ}_{2} = {\sum }_{ⅈ ∈ {S}_{2}} \{ i \cdot [ {P}_{r} ( i \vert {C}_{2} ) ] \} , {S}_{2} = [ k + 1 , … , {L}_{1} ] & ( 20 )\end{matrix}$$

Note that Pᵣ(i|C₁) and Pᵣ(i|C₂) are the occurrence probabilities of the luminance value i in the classes C₁ and C₂ and defined by

Pᵣ(i|C₁)=Pᵢ/ω(k) (21)

Pᵣ(i|C₂)=Pᵢ/[1−ω(k)] (22)

In summary,

μ₁=μ(k)/ω(k) (23)

μ₂={μ_{T}−μ(k)}/[1−ω(k)] (24)

Thus, the boundary estimation unit 55 calculates an inter-class variance σ_{B}² by

$$\begin{matrix}{σ}_{B}^{2} = {\sum }_{i ∈ S1} [ {( {μ}_{1} - {μ}_{T} )}^{2} \cdot Pi ] + {\sum }_{i ∈ S2} [ {( {μ}_{2} - {μ}_{T} )}^{2} \cdot Pi ] \\ = ω ( k ) \cdot {( {μ}_{1} - {μ}_{T} )}^{2} + [ 1 - ω ( k ) ] \cdot {( {μ}_{2} - {μ}_{T} )}^{2} \\ = {[ {μ}_{T} \cdot ω ( k ) - μ ( k ) ]}^{2} / \{ ω ( k ) \cdot [ 1 - ω ( k ) ] \}\end{matrix} \qquad ( 25 )$$

The boundary estimation unit 55 obtains the parameter k with which the inter-class variance σ_{B}² is maximized by performing the above processing (calculating the inter-class variance σ_{B}²) while changing the parameter k. This parameter k with which the inter-class variance σ_{B}² is maximized is the temporary parameter (luminance value) T′.

The boundary estimation unit 55 then calculates the likelihood parameter value (luminance value) k again, which is used to divide the distribution into two distributions, from the calculated temporary parameter value (luminance value) T′ with respect to only the area 350g (see FIG. 19) on the background distribution side by using the above inter-class variance technique. The parameter value (luminance value) k obtained in this manner becomes the “threshold T (luminance value)” for determining the boundary between the wafer image and the background image.

In the third boundary estimation technique, the boundary (threshold T) between a wafer image and a background is estimated in the above manner.

After this operation, the boundary estimation unit 55 estimates the periphery of the wafer by binarizing the image pick-up result data IMD1 on the basis of the threshold T as in the first and second boundary estimation techniques. The boundary estimation unit 55 stores the calculated estimated boundary position, threshold T, binarized image, and the like in the estimated boundary position storage area 74.

<Fourth Boundary Estimation Method>

In the fourth estimation technique, the boundary between a wafer image and a background is estimated by using the histogram data (luminance distribution data) shown in FIG. 16.

First of all, the boundary estimation unit 55 uses a predetermined data count (threshold) S determined (obtained) in advance by experiments or simulations to extract peaks of which the peak values are equal to or more than the data count S. In the case shown in FIG. 16, three peaks P10, P20 and P30 are extracted.

The boundary estimation unit 55 obtains an average luminance value Lm of luminance values L10 and L20 of the two peaks P10 and P20, of the above three peaks, at which the highest and second highest frequencies appear. The obtained average luminance value Lm becomes the “threshold T (luminance value)” for determining the boundary between the wafer image and the background.

Note that the weighted average of the luminance values L10 and L20 may be calculated by using weights corresponding to the maximum frequencies at the two peaks P10 and P20, and a weighted average Lwm obtained by this calculation may be used as the “threshold T (luminance value)” for determining the boundary between the wafer image and the background image.

In the above weighted average calculation, weights corresponding to the maximum probabilities or variances in the respective probability distributions in FIG. 17 may be used.

Alternatively, two peaks exhibiting the highest and second highest maximum probabilities may be extracted from the probability distribution data shown in FIG. 17, and the average of the luminance values of the two peaks may be obtained as the “threshold T”. In this case as well, weighted average calculation may be performed by using weights corresponding to the above maximum probabilities or variances.

According to the fourth boundary estimation technique, the threshold T (luminance value) for determining the boundary between a wafer image and a background image is estimated in the above manner.

After this operation, the boundary estimation unit 55 estimates the periphery of the wafer by binarizing the image pick-up result data IMD1 on the basis of the threshold T as in the above boundary estimation techniques, and stores the calculated estimated boundary position, threshold T, binarized image, and the like in the estimated boundary position storage area 74.

<Fifth Boundary Estimation Technique>

In the fifth boundary estimation technique, the boundary between a wafer image and a background is estimated by using the differential waveform data 320 shown in FIG. 21.

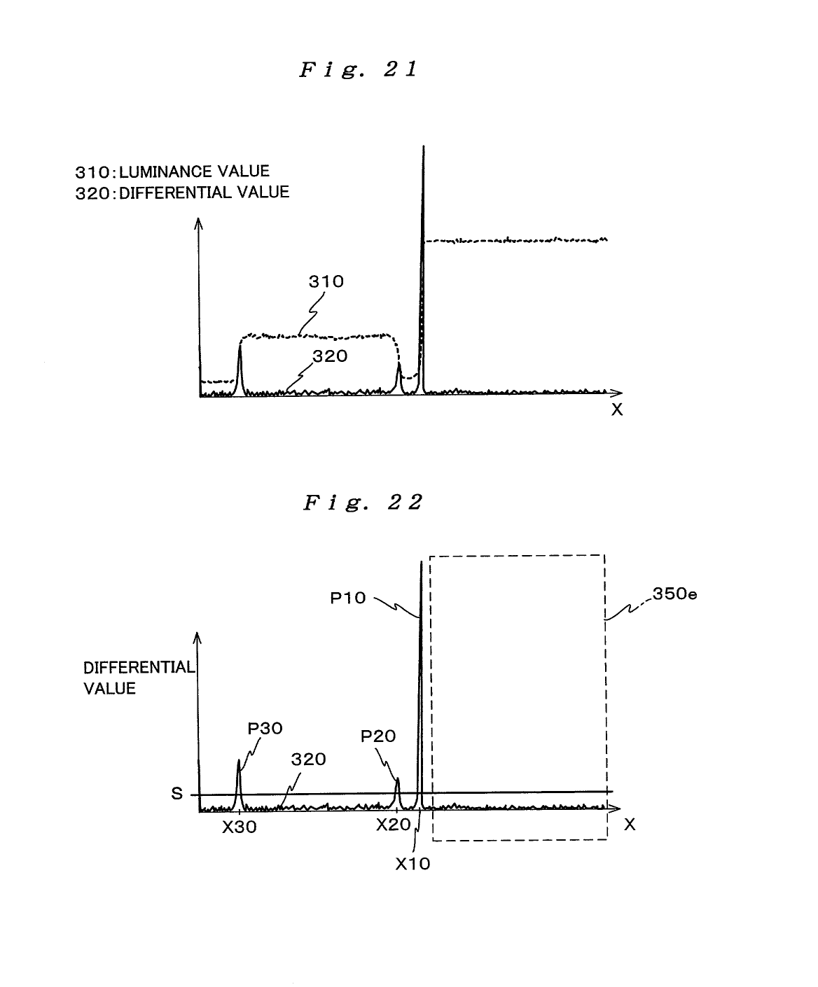

First of all, the boundary estimation unit 55 uses a predetermined differential value (threshold value) S determined (obtained) in advance by experiments or simulations to extract peaks exhibiting values equal or more than the different values S (see FIG. 22). In the case shown in FIG. 22, three peaks P10, P20, and P30 are extracted. These three peaks are boundary candidates (contour candidates).

The boundary position between the wafer image and the background (the contour position of the wafer image) is then obtained by using one of the following two techniques (first and second differential value utilization techniques).

[First Differential Value Utilization Technique]

In this technique, a boundary position is determined by a maximum differential value. As shown in FIG. 22, there are a plurality of (three in the case shown in FIG. 22) luminance value differences in the image pick-up data. Since the contour of the wafer image is the luminance difference between the background and the wafer, the contour position of the wafer image is expected to exhibit the largest luminance value difference.

On the basis of the above idea, a peak position X10 of the peak P10 exhibiting the maximum differential value among the multiple differential value candidates shown in FIG. 22 is estimated as a contour candidate. This peak position X10 is estimated as an estimated contour position (estimated boundary position).

[Second Differential Value Utilization Technique]

It is conceivable that the contour of a wafer lies between the background and the wafer. On the basis of this idea, in this technique, the peak position X10 of the peak P10, of the multiple differential value candidates shown in FIG. 22, which is nearest to the background side (a right area 350e in FIG. 22) is estimated as a contour candidate, and the peak position X10 is estimated as an estimated contour position (estimated boundary position).

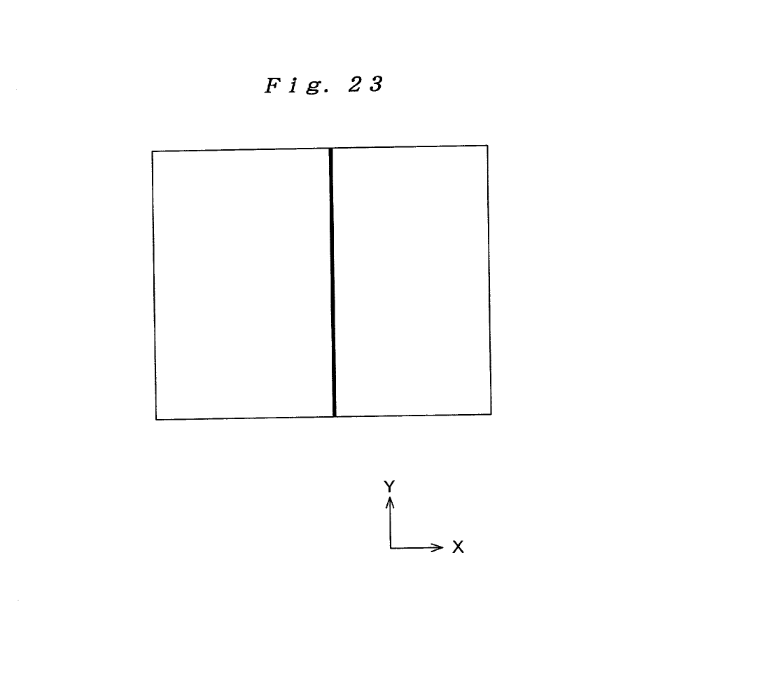

The boundary estimation unit 55 extracts a contour from the image pick-up result data IMD1 on the basis of the contour position estimated in the above manner. FIG. 23 shows an image obtained by extracting a contour in this manner. The periphery of the actual wafer can be estimated on the basis of this contour extraction result.

The boundary estimation unit 55 then stores the estimated boundary position, contour-extracted image (see FIG. 23), and the like obtained in the above manner in the estimated boundary position storage area 74.

The five boundary estimation techniques have been described above. The technique of obtaining a “threshold” for dividing a data distribution (luminance data distribution or unique pattern distribution) of data having two peaks into two classes (sets) (the technique of binarizing data) is not limited to any technique described in the above boundary estimation techniques, and various known binarization techniques may be used.

According to the above description, the obtained data (image pick-up data) is finally binarized. However, the present invention is not limited to this and can be applied to a case wherein the data is finally multileveled (e.g., having three or more levels), i.e., a plurality of boundaries are obtained.

Referring back to FIG. 15, in step 233, the parameter calculation unit 56 calculates the central position Qw and radius Rw of the area within the wafer by using a statistical technique such as the least squares method on the basis of the above estimated boundary position (information stored in the estimated boundary position storage area 74).

The parameter calculation unit 56 stores the central position Qw and radius Rw obtained in this manner in the measurement result storage area 75.

Subroutine 205 is completed in this manner, and the flow returns to the main routine in FIG. 13.

In step 206, the control unit 59 performs an exposure preparation measurement other than the above measurement on the shape of the wafer W. More specifically, the control unit 59 detects the positions of the notch N and orientation flat of the wafer W on the basis of the image pick-up data of the portion near the periphery of the wafer W which is stored in an image pick-up data storage area 71. With this operation, the rotational angle of the loaded wafer W around the Z-axis is detected. The wafer holder 25 is then rotated/driven through the stage control system 19 and wafer driving unit 24, as needed, on the basis of the detected rotational angle of the wafer W around the Z-axis.

The control unit 59 performs reticle alignment by using a reference mark plate (not shown) placed on the substrate table 26, and also makes preparations for a measurement on the baseline amount by using the alignment detection system AS. Assume that exposure on the wafer W is exposure on the second or subsequent layer. In this case, to form a circuit pattern with a high overlay accuracy with respect to the circuit pattern that has already been formed, the positional relationship between a reference coordinate system that defines the movement of the wafer W, i.e., the wafer stage WST, and the arrangement coordinate system associated with the arrangement of the circuit pattern on the wafer W, i.e., the arrangement of the chip area is detected with high precision by the alignment detection system AS on the basis of the above measurement result on the shape of the wafer W.

In step 207, exposure on the first layer is performed. In performing this exposure, first of all, the wafer stage WST is moved to set the X-Y position of the wafer W to the scanning start position where the first shot area (first shot) on the wafer W is exposed. This movement is performed by the control system 20 through the stage control system 19, wafer driving unit 24, and the like on the basis of the measurement result on the shape of the wafer W, read out from the measurement result storage area 75, the position information (velocity information) from a wafer interferometer 18, and the like (in the case of exposure on the second or subsequent layer, the detection result on the positional relationship between the reference coordinate system and the arrangement coordinate system, the position information (velocity information) from the wafer interferometer 18, and the like). At the same time, the reticle stage RST is moved to set the X-Y position of the reticle R to the scanning start position. This movement is performed by the control system 20 through the stage control system 19, reticle driving unit (not shown), and the like.

The stage control system 19 relatively moves the reticle R and wafer W, while adjusting the surface position of the wafer W, through the reticle driving unit (not shown) and stage driving unit 24 in accordance with an instruction from the control system 20 on the basis of the Z position information of the wafer, detected by the multiple focal position detection system, the X-Y position information of the reticle R, measured by the reticle interferometer 16, and the X-Y position information of the wafer W, measured by the wafer interferometer 18, thereby performing scanning exposure.

When exposure on the first shot area is completed in this manner, the wafer stage WST is moved to set the next shot area to the scanning start position so as to perform exposure thereon. At the same time, the reticle stage RST is moved to set the X-Y position of the reticle R to the scanning start position. Scanning exposure on this shot area is then performed in the same manner as the first shot area described above. Subsequently, scanning exposure is performed on the respective shot areas in the same manner to complete the exposure.

In step 208, the wafer W having undergone the exposure is unloaded from the substrate table 26 by a wafer unloader (not shown). As a consequence, the exposure processing for the wafer W is terminated.

The exposure apparatus 200 of this embodiment is manufactured as follows. The respective components shown in FIG. 10 and the like described above are mechanically, optically, and electrically combined with each other. Thereafter, overall adjustment (electrical adjustment, operation check, and the like) is performed on the resultant structure. Note that the exposure apparatus 200 is preferably manufactured in a clean room in which temperature, cleanliness, and the like are controlled.

The above boundary estimation (outer shape extraction or contour extraction) techniques are not limited to the extraction of the outer shape of a wafer and can be used to extract the outer shapes of various objects. For example, these techniques can be used to measure an illumination σ (coherence factor σ of a projection optical system), which influences the imaging characteristics of the projection optical system, by extracting the outer shape of a light source image, as disclosed in Japanese Patent Laid-Open No. 10-335207 and Japanese Patent No. 2928277.

The boundary estimation techniques in the second embodiment described above are not limited to classification of image pick-up data. These techniques can be used to obtain a boundary (threshold) for classifying a data group into two (or three or more) divided data groups as long as the data group is made up of various kinds of data and has a data distribution with at least three peaks.

Each embodiment described above has exemplified the scanning exposure apparatus. However, the present invention is adaptable to any wafer exposure apparatuses and liquid crystal exposure apparatuses such as a reduction projection exposure apparatus using ultraviolet light as a light source, a reduction projection exposure apparatus using soft X-rays having a wavelength of about 30 nm as a light source, an X-ray exposure apparatus using light having a wavelength of about 1 nm as a light source, and an exposure apparatus using an EB (Electron Beam) or ion beam. In addition, the present invention can be applied to any exposure apparatuses regardless of whether they are step-and-repeat exposure apparatuses, step-and-scan exposure apparatuses, or step-and-stitching apparatuses.

Each embodiment described above has exemplified the detection of the positions of positioning marks on a wafer and positioning of the wafer in the exposure apparatus. However, position detection and positioning to which the present invention is applied can also be used for the detection of positioning marks on a reticle, position detection, and positioning of the reticle. In addition, the above techniques can be used for the detection of the positions of objects and positioning of the objects in apparatuses other than exposure apparatuses, e.g., object observation apparatuses using a microscope and the like and object positioning apparatuses in an assembly line, processing line, and inspection line in factories.

The signal processing method and apparatus of the present invention are not limited to processing for the image pick-up signals obtained from marks in an exposure apparatus, and can be used for signal processing in, for example, an object observation apparatus using a microscope and the like. In addition, they can be used in various cases wherein signal components and noise components are discriminated from each other in signal waveforms.

The data classification method and apparatus of the present invention are not limited to the discrimination of signal components and noise components in signal processing, but can be used in any case wherein statistically rational data classification is performed when the contents of a data group are unknown.

<<Device manufacturing>>

A device manufacturing method using the exposure apparatus and exposure method in the above embodiments will be described.

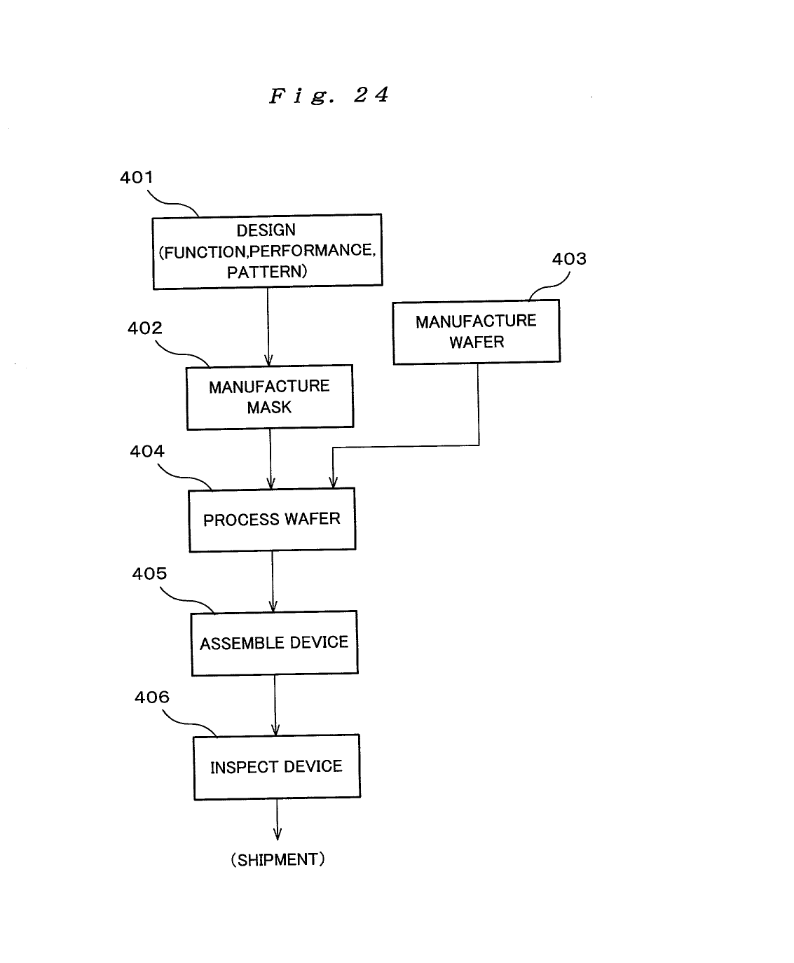

FIG. 24 is a flowchart showing an example of manufacturing a device (a semiconductor chip such as an IC, or LSI, a liquid crystal panel, a CCD, a thin film magnetic head, or a micromachine). As shown in FIG. 24, in step 401 (design step), function/performance is designed for a device (e.g., circuit design for a semiconductor device) and a pattern to implement the function is designed. In step 402 (mask manufacturing step), a mask on which the designed circuit pattern is formed is manufactured. In step 403 (wafer manufacturing step), a wafer is manufacturing by using a material such as silicon.

In step 404 (wafer processing step), an actual circuit, etc. are formed on the wafer by lithography using the mask and wafer prepared in steps 401 to 403, as will be described later. In step 405 (device assembly step), a device is assembled by using the wafer processed in step 404, thereby forming the device into a chip. Step 405 includes processes (dicing and bonding) and packaging (chip encapsulation).

Finally, in step 406 (inspection step), a test on the operation of the device manufactured in step 405 and durability test, etc. are performed. After these steps, the device is completed and shipped out.

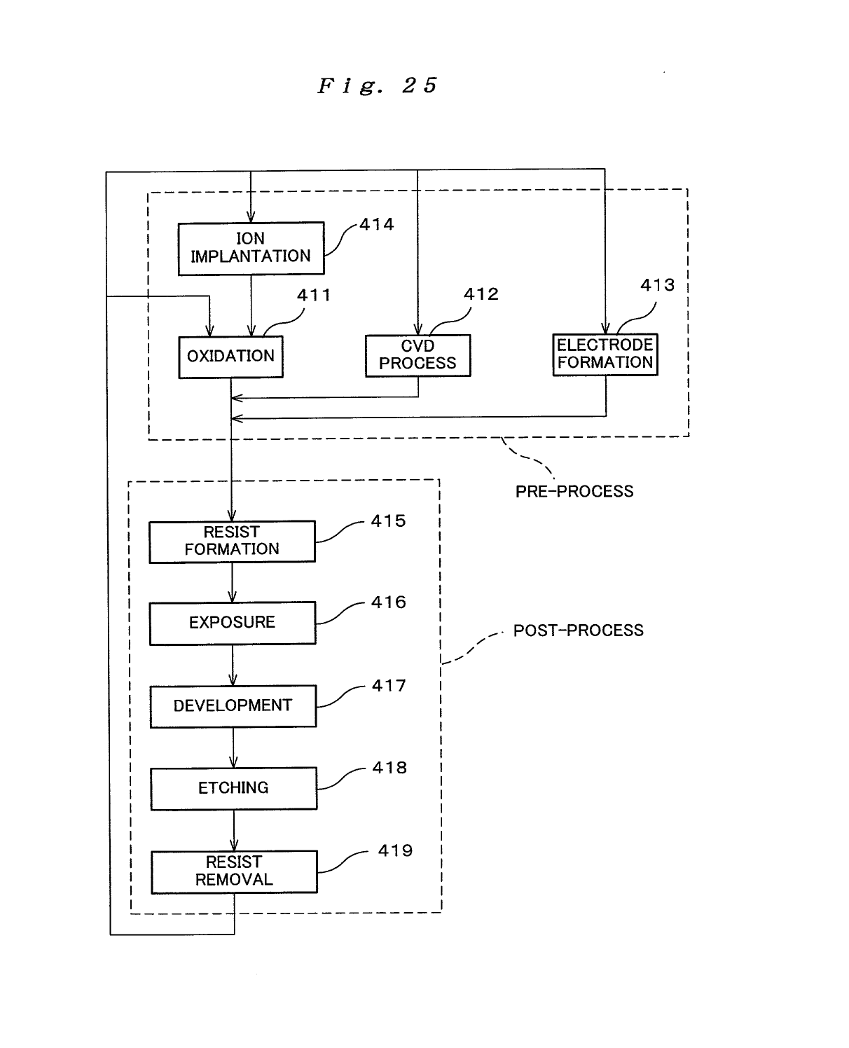

FIG. 25 is a flowchart showing the detailed example of step 404 described above in manufacturing the semiconductor device. Referring to FIG. 25, in step 411 (oxidation step), the surface of the wafer is oxidized. In step 412 (CVD step), an insulation film is formed on the wafer surface. In step 413 (electrode formation step), an electrode is formed on the wafer by vapor deposition. In step 414 (ion implantation step), ions are implanted into the wafer. Steps 411 to 414 described above constitute a pre-process for the respective steps in the wafer process and are selectively executed in accordance with the processing required in the respective steps.

When the above pre-process is completed in the respective steps in the wafer process, a post-process is executed as follows. In this post-process, first, in step 415 (resist formation step), the wafer is coated with a photosensitive agent. Next, in step 416 (exposure step), the circuit pattern on the mask is transcribed onto the wafer by the above exposure apparatus and method. Then, in step 417 (developing step), the exposed wafer is developed. In step 418 (etching step), an exposed member on a portion other than a portion where the resist is left is removed by etching. Finally, in step 419 (resist removing step), the unnecessary resist after the etching is removed.

By repeatedly performing these pre-process and post-process, multiple circuit patterns are formed on the wafer.

As described above, the device on which the fine patterns are precisely formed is manufactured.

While the above-described embodiments of the present invention are the presently preferred embodiments thereof, those skilled in the art of lithography system will readily recognize that numerous additions, modifications and substitutions may be made to the above-described embodiments without departing from the spirit and scope thereof. It is intended that all such modifications, additions and substitutions fall within the scope of the present invention, which is best defined by the claims appended below.

What is claimed is:

1. A data classification method of classifying a group of data into a plurality of sets in accordance with data values, comprising:
dividing said group of data into a first number of sets having no common elements; and
calculating a first total degree of randomness which is a sum of degrees of randomness of said data values in said respective sets of said first number of sets,
wherein data division to said first number of sets and calculation of said first total degree of randomness are repeated while a form of data division to said first number of sets is changed, and said group of data is classified into data belonging to the respective classification sets of said first number of classification sets in which said first total degree of randomness is minimized.

2. The method according to claim 1, wherein data division to said first number of sets is performed for data to be classified in numerical order of data values.

3. The method according to claim 1, wherein said calculating the sum of degrees of randomness in the respective sets of said first number of sets comprises:
estimating a probability distribution of data values in each of said sets on the basis of said data values of said data belonging to each of said sets;
obtaining an entropy of each of said estimated probability distributions of data values; and
weighting said entropy of each of said probability distributions in accordance with the number of data belonging to a corresponding one of said sets.

4. The method according to claim 3, wherein said first probability distribution is a normal distribution.

5. The method according to claim 1, further comprising:
dividing data belonging to a specific classification set in said first number of classification sets into a second number of sets having no common elements; and
calculating a second total degree of randomness which is a sum of degrees of randomness of data values in the respective sets of said second number of sets,
wherein data division to said second number of sets and calculation of said second total degree of randomness are repeated while a form of data division to said second number of sets is changed, and said data belonging to said specific classification set are further classified into data belonging to the respective classification sets of said second number of classification sets in which said second total degree of randomness is minimized.

6. The method according to claim 5, wherein data division to said second number of sets is performed for data to be classified in numerical order of data values.

7. The method according to claim 5, wherein said calculating the sum of degrees of randomness in the respective sets of said second number of sets comprises:
estimating a probability distribution of data values in each of the sets on the basis of said data values of said data belonging to each of said sets;
obtaining an entropy of each of the estimated probability distributions of data values; and
weighting said entropy of each of said probability distributions in accordance with the number of data belonging to a corresponding one of said sets.

8. The method according to claim 7, wherein said first probability distribution is a normal distribution.

9. A data classification apparatus for classifying a group of data into a plurality of sets in accordance with data values, comprising:
a first data dividing unit which divides said group of data into a first number of sets having no common elements; and
a first degree-of-randomness calculation unit which calculates degrees of randomness of data values in the respective sets divided by said first data dividing unit, and calculates a sum of the degrees of randomness; and
a first classification unit which classifies said group of data into said data belonging to the respective classification sets of said first number of classification sets in which said sum of degrees of randomness calculated by said first degree-of-randomness calculation unit is minimum out of forms of data division by said first data dividing unit.

10. The apparatus according to claim 9, further comprising:
a second data dividing unit which divides data belonging to a specific classification set in the first number of classification sets into a second number of sets having no common elements; and
a second degree-of-randomness calculation unit which calculates degrees of randomness of data values in the respective sets divided by said second data dividing unit and calculates a sum of the degrees of randomness; and
a second classification unit which classifies said data of said specific classification set into said data belonging to the respective classification sets of said second number of classification sets in which said sum of degrees of randomness calculated by said second degree-of-randomness calculation unit is minimum out of forms of data division by said second data dividing unit.

11. A signal processing method of processing a measurement signal obtained by measuring an object, comprising:
extracting signal levels at a plurality of feature points obtained from said measurement signal; and
setting said extracted signal levels as classification object data and classifying said signal levels at said group of feature points into a plurality of sets by using the data classification method according to claim 1.

12. The method according to claim 11, wherein said feature point is at least one of a local maximum point and a local minimum point of said measurement signal.

13. The method according to claim 11, wherein said feature point is a point of inflection of said measurement signal.

14. A signal processing apparatus for processing a measurement signal obtained by measuring an object, comprising:
a measurement unit which measures said object and acquires a measurement signal;
an extraction unit which extracts signal levels at a plurality of feature points obtained from said measurement signal; and
the data classification apparatus according to claim 9, which sets said extracted signal levels as classification object data.

15. A position detection method of detecting a position of a mark formed on an object, comprising:
acquiring an image pick-up signal by picking up an image of said mark;
processing said image pick-up signal as a measurement signal by said signal processing method according to claim 11; and
calculating said position of said mark on the basis of a signal processing result obtained in said signal processing.

16. The method according to claim 15, wherein
in data classification in said signal processing, the number of data which should belong to each classification set after said data classification is known in advance, and
in said position calculation, the number of data which should belong to each classification set is compared with the number of data in each of said classification sets classified in said signal processing to evaluate validity of the classification in said signal processing, and said position is calculated on the basis of said data belonging to said classification set evaluated to be valid.

17. A position detection apparatus for detecting a position of a mark formed on an object, comprising:
an image pick-up unit which acquires an image pick-up signal by picking up an image of said mark;
the signal processing apparatus according to claim 14, which performs signal processing for said image pick-up signal as a measurement signal; and
a position calculation unit which calculates said position of said mark on the basis of a signal processing result obtained by said signal processing apparatus.

18. An exposure method of transferring a predetermined pattern onto a divided area on a substrate, comprising:
detecting a position of a position detection mark formed on said substrate by the position detection method according to claim 15, obtaining a predetermined number of parameters associated with a position of said divided area, and calculating arrangement information of said divided area on said substrate; and
transferring said pattern onto said divided area while performing position control on said substrate on the basis of said arrangement information of said divided area obtained in said arrangement calculation.

19. An exposure apparatus for transferring a predetermined pattern onto a divided area on a substrate, comprising:
a substrate stage on which said substrate is mounted; and
the position detection apparatus according to claim 17, which detects a position of said mark on said substrate.

20. A data classification method of classifying a group of data into a plurality of sets in accordance with data values, comprising:
classifying said group of data into a first number of sets in accordance with said data values; and
dividing said group of data again into a second number of sets which is smaller than said first number on the basis of a characteristic of each of said first number of sets divided in data classification into said first number of sets.

21. The method according to claim 20, wherein data classification into said second number of sets comprises:
specifying a first set, of said first number of sets, which meets a predetermined condition;
estimating a first boundary candidate for dividing said group of data excluding data included in said first set by using a predetermined estimation technique;
estimating a second boundary candidate for dividing a data group, of said group of data, which is divided by said first boundary candidate and includes said first set by using said predetermined estimation technique; and
dividing said group of data into said second number of sets on the basis of said second boundary candidate.

22. The method according to claim 21, wherein said predetermined estimation technique comprises:
calculating a degree of randomness of data values in each set divided by said boundary candidate, and calculating a sum of said degrees of randomness; and
performing said degree-of-randomness calculation while changing a form of data division with said boundary candidate, and extracting a boundary candidate with which said sum of degrees of randomness obtained in said degree-of-randomness calculation is minimized.

23. The method according to claim 21, wherein said predetermined estimation technique comprises:
obtaining a probability distribution in each set of said data group; and
extracting said boundary candidate on the basis of a point of intersection of said probability distributions of the respective sets.

24. The method according to claim 21, wherein said predetermined estimation technique comprises:
calculating an inter-class variance as a variance between sets divided by said boundary candidate; and
performing said intra-class variance calculation while changing a form of data division with said boundary candidate, and extracting a boundary candidate with which the inter-class variance obtained in said inter-class variance calculation is maximized.

25. The method according to claim 21, wherein said predetermined condition is a condition that data exhibiting a value substantially equal to a predetermined value is extracted from said group of data.

26. The method according to claim 25, wherein
said group of data is image pick-up data of the respective pixels obtained by picking up different image patterns within a predetermined image pick-up field; and
said predetermined value is image pick-up data of a pixel existing in an area corresponding to an image pick-up area for a predetermined image pattern.

27. The method according to claim 20, wherein said dividing data into said second number of sets comprises:
extracting a predetermined number of sets from the first number of sets on the basis of the number of data included in the respective sets of said first number of sets;
calculating an average data value by averaging data values respectively representing sets of said predetermined number of sets; and
dividing said group of data into said second number of sets on the basis of said average data value.

28. The method according to claim 27, wherein in said average data value calculation, a weighted average of said data values is calculated by using a weight corresponding to at least one of the number of data of the respective sets of said predetermined number of sets and a probability distribution of said predetermined number of sets.

28. The method according to claim 20, wherein said first number is not less than three, and said second number is two.

29. The method according to claim 20, wherein said group of data is luminance data of the respective pixels obtained by picking up different image patterns within a predetermined image pick-up field.

30. A data classification apparatus for classifying a group of data into a plurality of sets in accordance with data values, comprising:
a first data dividing unit which divides said group of data into a first number of sets on the basis of said data values; and
a second data dividing unit which divides said group of data into a second number of sets smaller than said first number again on the basis of a characteristic of each of said first number of sets.

31. The method according to claim 30, wherein said first number is not less than three, and said second number is two.

32. An image processing method of processing image data obtained by picking up an image in a predetermined image pick-up field, comprising:
setting luminance data, as a group of data, which is obtained by picking up an image pattern of an object and an image pattern of a background which exist in said predetermined image pick-up field; and
identifying a boundary between said object and said background by classifying said luminance data by using the data classification method according to claim 29.

33. The method according to claim 32, wherein said object includes a substrate onto which a predetermined pattern is transferred.

34. An image processing apparatus for processing image data obtained by picking up an image in a predetermined image pick-up field, wherein
luminance data, which is obtained by picking up an image pattern of an object and an image pattern of a background which exist in said predetermined image pick-up field is set as a group of data, and
a boundary between said object and said background is identified by classifying said luminance data by using the data classification apparatus according to claim 30.

35. An exposure method of transferring a predetermined pattern onto a substrate, comprising:
specifying an outer shape of said substrate by using the image processing method according to claim 33;
controlling a rotational position of said substrate on the basis of said specified outer shape of said substrate;
detecting a mark formed on said substrate after said rotational position is controlled; and
transferring said predetermined pattern onto said substrate while positioning said substrate on the basis of a mark detection result obtained in said mark detection.

36. An exposure apparatus for transferring a predetermined pattern onto a substrate, comprising:
an outer shape specifying unit including the image processing apparatus according to claim 34, which specifies an outer shape of said substrate;
a rotational position control unit which controls a rotational position of said substrate on the basis of said outer shape of said substrate which is specified by said image processing apparatus;
a mark detection unit which detects a mark formed on said substrate whose rotational position is controlled by said rotational position control unit; and
a positioning unit which positions said substrate on the basis of a mark detection result obtained by said mark position detection unit,
wherein said predetermined pattern is transferred onto said substrate while said substrate is positioned by said positioning unit.

37. A data classification method of classifying a group of data into a plurality of sets in accordance with data values, comprising:
estimating a first number of boundary candidates for dividing said group of data into a second number of sets on the basis of said data values; and
extracting a third number of boundary candidates which is smaller than said first number and is used to divide said group of data into a fourth number of sets smaller than said second number, under a predetermined extraction condition, on the basis of said first number of boundary candidates.

38. The method according to claim 37, wherein said predetermined extraction condition includes a condition that said third number of boundary candidates are extracted on the basis of a magnitude of a data value indicated by each of said first number of boundary candidates.

39. The method according to claim 38, wherein said predetermined extraction condition includes a condition that a boundary candidate with which said data value is maximized is extracted.

40. The method according to claim 37, wherein
said group of data are arranged at positions in a predetermined direction, and
said predetermined extraction condition includes a condition that said fourth number of boundary candidates are extracted on the basis of the respective positions of said first number of boundary candidates.

41. The method according to claim 37, wherein
said group of data are differential data obtained by differentiating image pick-up data of the respective pixels obtained by picking up different image patterns in a predetermined image pick-up field in accordance with positions of said pixels,
said data value is a differential value of said image pick-up data, and
said boundary candidate is a position of said pixel.

42. The method according to claim 37, wherein said first number is not less than two, and said third number is one.

43. The method according to claim 37, wherein said group of data are luminance data of the respective pixels obtained by picking up different image patterns in a predetermined image pick-up field.

44. A data classification apparatus for classifying a group of data into a plurality of sets in accordance with data values, comprising:
a first data dividing unit which estimates a first number of boundary candidates for dividing said group of data into a second number of sets on the basis of said data values; and
a second data dividing unit which extracts a third number of boundary candidates which is smaller than said first number and is used to divide said group of data into a fourth number of sets smaller than said second number, under a predetermined extraction condition, on the basis of said first number of boundary candidates.

45. The apparatus according to claim 44, wherein
said group of data are differential data obtained by differentiating image pick-up data of the respective pixels obtained by picking up different image patterns in a predetermined image pick-up field in accordance with positions of said pixels,
said data value is a differential value of said image pick-up data, and
said boundary candidate is a position of said pixel.

46. The apparatus according to claim 44, wherein said first number is not less than two, and said third number is one.

47. An image processing method of processing image data obtained by picking up an image in a predetermined image pick-up field, comprising:
setting luminance data, as a group of data, which is obtained by picking up an image pattern of an object and an image pattern of a background which exist in the predetermined image pick-up field; and
identifying a boundary between said object and said background by classifying said luminance data by using the data classification method according to claim 37.

48. An image processing apparatus for processing image data obtained by picking up an image in a predetermined image pick-up field, wherein
luminance data which is obtained by picking up an image pattern of an object and an image pattern of a background which exist in said predetermined image pick-up field is set as a group of data, and
a boundary between said object and said background is identified by classifying said luminance data by using the data classification apparatus according to claim 44.

49. An exposure method of transferring a predetermined pattern onto a substrate, comprising:
specifying an outer shape of said substrate by using the image processing method according to claim 47;
controlling a rotational position of said substrate on the basis of said specified outer shape of said substrate;
detecting a mark formed on said substrate after said rotational position is controlled; and
transferring said predetermined pattern onto said substrate while positioning said substrate on the basis of a mark detection result obtained in said mark detection.

50. An exposure apparatus for transferring a predetermined pattern onto a substrate, comprising:
an outer shape specifying unit including the image processing apparatus according to claim 48, which specifies an outer shape of said substrate;
a rotational position control unit which controls a rotational position of said substrate on the basis of said outer shape of said substrate which is specified by said image processing apparatus;
a mark detection unit which detects a mark formed on said substrate whose rotational position is controlled by said rotational position control unit; and
a positioning unit which positions said substrate on the basis of a mark detection result obtained by said mark position detection unit,
wherein said predetermined pattern is transferred onto said substrate while said substrate is positioned by said positioning unit.

51. A recording medium on which a position detection control program executed by a position detection apparatus for detecting a position of a mark formed on an object is recorded, wherein
said position detection control program comprises:
allowing an image of said mark to be picked up and allowing an image pick-up signal to be acquired;
a signal processing control program using said image pick-up signal as a measurement signal, comprising
allowing signal levels at a plurality of feature points obtained from said measurement signal to be extracted; and
said data classification control program using said extracted signal levels as a group of classification object data, comprising
allowing said group of data to be divided into a first number of sets having no common elements;
allowing a first total degree of randomness which is a sum of degrees of randomness of data values in the respective sets of said first number of sets to be calculated; and
allowing said group of data to be divided into data belonging to the respective classification sets of said first number of classification sets in which said first total degree of randomness is minimized, by repeating data division to said first number and calculation of said first total degree of randomness while changing a mode of data division to said first number of sets; and
allowing a position of said mark to be calculated on the basis of a processing result on said image pick-up signal.

52. The medium according to claim 51, wherein
in said data classifying, the number of data which should belong to each classification set after said data classification is known in advance, and
the number of data which should belong to each classification set is compared with the number of data in each of said classified classification sets to evaluate validity of said data classifying, and said position is calculated on the basis of data belonging to said classification set evaluated to be valid.

53. A recording medium on which an image processing control program executed by an image processing apparatus for processing image data obtained by picking up an image in a predetermined image pick-up field is recorded, wherein
said image processing control program comprises:
allowing luminance data, which is obtained by picking up an image pattern of an object and an image pattern of a background which exist in said predetermined image pick-up field, to be set as a group of data;
a data classification control program which allows said luminance data to be classified, comprising:
allowing said group of data to be divided into a first number of sets on the basis of said data values; and
allowing said group of data to be divided into a second number of sets smaller than said first number again on the basis of features of the respective first number of sets; and
allowing a boundary between said object and said background to be identified.

54. A recording medium on which an image processing control program executed by an image processing apparatus for processing image data obtained by picking up an image in a predetermined image pick-up field is recorded, wherein
said image processing control program comprises:
allowing luminance data which is obtained by picking up an image pattern of an object and an image pattern of a background which exist in said predetermined image pick-up field to be set as a group of data;
a data classification control program which allows said luminance data to be classified, comprising
allowing a first number of boundary candidates for dividing said group of data into a second number of sets to be estimated on the basis of said data values;
allowing a third number of boundary candidates which is smaller than said first number and is used to divide said group of data into a fourth number of sets smaller than said second number, under a predetermined extraction condition, to be extracted on the basis of said first number of boundary candidates; and
allowing a boundary between said object and said background to be identified.

55. A device manufacturing method including a lithography process, wherein
exposure is performed by using the exposure method according to claim 18 in said lithography process.

56. A device manufacturing method including a lithography process, wherein
exposure is performed by using the exposure method according to claim 35 in said lithography process.

57. A device manufacturing method including a lithography process, wherein
exposure is performed by using the exposure method according to claim 49 in said lithography process.
